(19) United States
(12) Patent Application Publication
(10) Pub. No.: US 2025/0334774 A1
(43) Pub. Date: Oct. 30, 2025

(54) OPTICAL IMAGING LENS ASSEMBLY

(71) Applicant: ZHEJIANG SUNNY OPTICS CO., LTD., Yuyao Ningbo (CN)

(72) Inventors: Xiuxun DOU, Yuyao Ningbo (CN); Jiajie YU, Yuyao Ningbo (CN); Linlin XIA, Yuyao Ningbo (CN); Jianke WENREN, Yuyao Ningbo (CN); Fujian DAI, Yuyao Ningbo (CN)

(73) Assignee: ZHEJIANG SUNNY OPTICS CO., LTD., Yuyao Ningbo (CN)

(21) Appl. No.: 18/960,175

(22) Filed: Nov. 26, 2024

(30) Foreign Application Priority Data
Apr. 26, 2024 (CN) 202410521307.X

(51) Int. Cl. G02B 9/64; G02B 13/18

(52) U.S. Cl. CPC G02B 9/64; G02B 13/18

(57) ABSTRACT

Provided is an optical imaging lens assembly. The optical imaging lens assembly includes a lens barrel, seven lenses and a plurality of spacers, where the seven lenses include a first lens having negative refractive power, a second lens having positive refractive power, a third lens having positive refractive power, a fourth lens having positive refractive power, a fifth lens having negative refractive power, a sixth lens having positive refractive power and a seventh lens having negative refractive power, and an air gap is provided between every two adjacent lenses of the first lens to the seventh lens; the plurality of spacers include a fourth spacer and a fifth spacer; 1<EP45/CT5<4 is satisfied; 1<R8/R9<4 is satisfied; and 0<d4s/(f4−f5)<0.5 is satisfied.

### CROSS-REFERENCE TO RELATED APPLICATION

This disclosure claims priority to Chinese Patent Application No. 202410521307.X filed to the China National Intellectual Property Administration on Apr. 26, 2024 and entitled “Optical Imaging Lens Assembly”, the entire contents of which are incorporated herein by reference for all purposes.

### TECHNICAL FIELD

The disclosure relates to the technical field of optical imaging apparatuses, and particularly relates to an optical imaging lens assembly.

### BACKGROUND

With the continuous advancement of technology and the increasing demands of consumers, mobile phones have become indispensable to our daily lives. The mobile phone has a plurality of functions. Especially as a photographing technology of the mobile phone is rapidly developed, increasing requirements are imposed on a performance of an optical imaging lens assembly on the mobile phone. Competition in high performance and high quality of the optical imaging lens assembly has become the focus of major manufacturers. Apart from definition and authenticity of color rendition, the consumers also expect the optical imaging lens assembly to capture wider pictures and richer details. At present, a design of a optical imaging lens assembly with seven-lenses is mostly adopted to satisfy market requirements. However, internal reflection is likely to occur on the optical imaging lens assembly with the seven-lenses. Internally-reflected light will produce stray light to affect imaging quality of the optical imaging lens assembly.

That is, the problem of severe internally-reflected stray light is discovered on the optical imaging lens assembly with the seven-lenses in the related art.

### SUMMARY

Some embodiments of the disclosure are to provide an optical imaging lens assembly, so as to solve the problem of severe internally-reflected stray light on a optical imaging lens assembly with seven-lenses in the related art.

According to an embodiment of the disclosure, an optical imaging lens assembly is provided. The optical imaging lens assembly includes a lens barrel, seven lenses and a plurality of spacers. The seven lenses and the plurality of spacers are arranged in the lens barrel. The seven lenses include, in sequence from an object side to an image side, a first lens having negative refractive power, a second lens having positive refractive power, a third lens having positive refractive power, a fourth lens having positive refractive power, a fifth lens having negative refractive power, a sixth lens having positive refractive power and a seventh lens having negative refractive power. An air gap is provided between every two adjacent lenses of the first lens to the seventh lens. The plurality of spacers at least include a fourth spacer and a fifth spacer. The fourth spacer is located between the fourth lens and the fifth lens and abuts against part of an image-side surface of the fourth lens. The fifth spacer is located between the fifth lens and the sixth lens and abuts against part of an image-side surface of the fifth lens. A distance EP45 between an image-side surface of the fourth spacer and an object-side surface of the fifth spacer on an optical axis and a center thickness CT5 of the fifth lens satisfy: 1<EP45/CT5<4. A curvature radius R8 of the image-side surface of the fourth lens and a curvature radius R9 of an object-side surface of the fifth lens satisfy: 1<R8/R9<4. An inner diameter d4s of the object-side surface of the fourth spacer, an effective focal length f4 of the fourth lens and an effective focal length f5 of the fifth lens satisfy: 0<d4s/(f4−f5)<0.5.

According to another embodiment of the disclosure, an optical imaging lens assembly is provided. The optical imaging lens assembly includes a lens barrel, seven lenses and a plurality of spacers. The seven lenses and the plurality of spacers are arranged in the lens barrel. The seven lenses include, in sequence from an object side to an image side, a first lens having negative refractive power, a second lens having positive refractive power, a third lens having positive refractive power, a fourth lens having positive refractive power, a fifth lens having negative refractive power, a sixth lens having positive refractive power and a seventh lens having negative refractive power. An air gap is provided between every two adjacent lenses of the first lens to the seventh lens. The plurality of spacers at least include a fourth spacer and a fifth spacer. The fourth spacer is located between the fourth lens and the fifth lens and abuts against part of an image-side surface of the fourth lens. The fifth spacer is located between the fifth lens and the sixth lens and abuts against part of an image-side surface of the fifth lens. A distance EP45 between an image-side surface of the fourth spacer and an object-side surface of the fifth spacer on an optical axis and a center thickness CT5 of the fifth lens satisfy: 1<EP45/CT5<4. A curvature radius R8 of the image-side surface of the fourth lens and a curvature radius R9 of an object-side surface of the fifth lens satisfy: 1<R8/R9<4. An inner diameter d5s of the object-side surface of the fifth spacer, an inner diameter d4m of the image-side surface of the fourth spacer, a curvature radius R9 of the object-side surface of the fifth lens and a curvature radius R10 of the image-side surface of the fifth lens satisfy: 0<d5s/R10−d4m/R9<1.5.

In an embodiment mode, the plurality of spacers further include a first spacer and a second spacer. The first spacer is located between the first lens and the second lens and abuts against part of an image-side surface of the first lens. The second spacer is located between the second lens and the third lens and abuts against part of an image-side surface of the second lens. An inner diameter dis of an object-side surface of the first spacer, an inner diameter d2s of an object-side surface of the second spacer and an effective focal length f2 of the second lens satisfy: 2<f2/(d1s−d2s)<10.

In an embodiment mode, the plurality of spacers further include a first spacer. The first spacer is located between the first lens and the second lens and abuts against part of an image-side surface of the first lens. An inner diameter d1m of an image-side surface of the first spacer, an outer diameter D1m of the image-side surface of the first spacer, and a distance T12 between the image-side surface of the first lens and an object-side surface of the second lens on the optical axis satisfy: 2<(D1m−d1m)/T12<6.

In an embodiment mode, the plurality of spacers further include a second spacer. The second spacer is located between the second lens and the third lens and abuts against part of an image-side surface of the second lens. An inner diameter d2s of an object-side surface of the second spacer, an inner diameter d2m of an image-side surface of the second spacer, a curvature radius R4 of the image-side surface of the second lens and a curvature radius R5 of an object-side surface of the third lens satisfy: −0.5<d2s/R4−d2m/R5<1.

In an embodiment mode, the plurality of spacers further include a third spacer. The third spacer is located between the third lens and the fourth lens and abuts against part of an image-side surface of the third lens. An inner diameter d3s of an object-side surface of the third spacer, an outer diameter D3m of an image-side surface of the third spacer, an effective focal length f3 of the third lens and an effective focal length f4 of the fourth lens satisfy: −5<(D3m−d3s)/(f4−f3)<15.

In an embodiment mode, the plurality of spacers further include a second spacer. The second spacer is located between the second lens and the third lens and abuts against part of an image-side surface of the second lens. An inner diameter d2m of an image-side surface of the second spacer, an effective diameter DT31 of a central light-transmitting region of an object-side surface of the third lens and an effective diameter DT22 of a central light-transmitting region of the image-side surface of the second lens satisfy: −18<d2m/(DT22−DT31)<8.

In an embodiment mode, the plurality of spacers further include a first spacer and a second spacer. The first spacer is located between the first lens and the second lens and abuts against part of an image-side surface of the first lens. The second spacer is located between the second lens and the third lens and abuts against part of an image-side surface of the second lens. An outer diameter D1s of an object-side surface of the first spacer, an outer diameter D2s of an object-side surface of the second spacer, an effective diameter DT12 of a central light-transmitting region of the image-side surface of the first lens and an effective diameter DT22 of a central light-transmitting region of the image-side surface of the second lens satisfy: 0<|D2s−D1s|/(DT12−DT22)<0.1.

In an embodiment mode, an inner diameter d5s of the object-side surface of the fifth spacer, an inner diameter d4m of the image-side surface of the fourth spacer, a curvature radius R9 of the object-side surface of the fifth lens and a curvature radius R10 of the image-side surface of the fifth lens satisfy: 0<d5s/R10−d4m/R9<1.5.

In an embodiment mode, the plurality of spacers further include a first spacer, a second spacer and a third spacer. The first spacer is located between the first lens and the second lens and abuts against part of an image-side surface of the first lens. The second spacer is located between the second lens and the third lens and abuts against part of an image-side surface of the second lens. The third spacer is located between the third lens and the fourth lens and abuts against part of an image-side surface of the third lens. The second spacer of the plurality of spacers has a minimum inner diameter. An inner diameter dls of an object-side surface of the first spacer, an inner diameter d2s of an object-side surface of the second spacer and an inner diameter d3s of an object-side surface of the third spacer satisfy: 0<(d1s−d2s)/(d3s−d2s)<3.

In an embodiment mode, an inner diameter d5s of the object-side surface of the fifth spacer, an inner diameter d5m of an image-side surface of the fifth spacer, an effective diameter DT52 of a central light-transmitting region of the image-side surface of the fifth lens and an effective diameter DT61 of a central light-transmitting region of an object-side surface of the sixth lens satisfy: 0<d5s/DT52−d5m/DT61<0.5.

In an embodiment mode, the plurality of spacers further include a sixth spacer. The sixth spacer is located between the sixth lens and the seventh lens and abuts against part of an image-side surface of the sixth lens. An inner diameter d6s of an object-side surface of the sixth spacer, a center thickness CT6 of the sixth lens and a center thickness CT7 of the seventh lens satisfy: 2<d6s/(CT6+CT7)<5.

In an embodiment mode, the plurality of spacers further include a first spacer and a sixth spacer. The first spacer is located between the first lens and the second lens and abuts against part of an image-side surface of the first lens. The sixth spacer is located between the sixth lens and the seventh lens and abuts against part of an image-side surface of the sixth lens. An outer diameter D1s of an object-side surface of the first spacer, an outer diameter D6m of an image-side surface of the sixth spacer, an effective diameter DT11 of a central light-transmitting region of an object-side surface of the first lens and an effective diameter DT72 of a central light-transmitting region of an image-side surface of the seventh lens satisfy: 1.7<D1s/D6m+DT11/DT72<2.1.

By using the technical solution of the disclosure, an optical imaging lens assembly includes a lens barrel, seven lenses and a plurality of spacers. The seven lenses and the plurality of spacers are arranged in the lens barrel. The seven lenses include, in sequence from an object side to an image side, a first lens having negative refractive power, a second lens having positive refractive power, a third lens having positive refractive power, a fourth lens having positive refractive power, a fifth lens having negative refractive power, a sixth lens having positive refractive power and a seventh lens having negative refractive power. An air gap is provided between every two adjacent lenses of the first lens to the seventh lens. The plurality of spacers at least include a fourth spacer and a fifth spacer. The fourth spacer is located between the fourth lens and the fifth lens and abuts against part of an image-side surface of the fourth lens. The fifth spacer is located between the fifth lens and the sixth lens and abuts against part of an image-side surface of the fifth lens. A distance EP45 between an image-side surface of the fourth spacer and an object-side surface of the fifth spacer on an optical axis and a center thickness CT5 of the fifth lens satisfy: 1<EP45/CT5<4. A curvature radius R8 of the image-side surface of the fourth lens and a curvature radius R9 of an object-side surface of the fifth lens satisfy: 1<R8/R9<4. An inner diameter d4s of the object-side surface of the fourth spacer, an effective focal length f4 of the fourth lens and an effective focal length f5 of the fifth lens satisfy: 0<d4s/(f4−f5)<0.5.

The optical imaging lens assembly in the disclosure is composed of a lens barrel, and seven lenses and a plurality of spacers arranged in the lens barrel. The seven lenses and the plurality of spacers are reasonably arranged. A fourth lens having positive refractive power and a fifth lens having negative refractive power are arranged. In a case that the optical imaging lens assembly satisfies: 1<EP45/CT5<4 and 1<R8/R9<4, a refraction direction of light passing through the fourth lens and the fifth lens may be effectively controlled. Thus, an image height of each position of a field of view may be ensured and final imaging quality may be ensured. Moreover, as shown in FIG. 24, a schematic diagram of an internal reflection optical path of an optical imaging lens assembly in the related art is shown. It may be seen from the figure that incident light from an object side is likely to be internally reflected at an effective-radius edge of an image-side surface of the fifth lens, and the light is repeatedly reflected in an edge structure of the fifth lens, reaches an effective-radius edge of an object-side surface of the fifth lens and then is emitted, such that stray light is formed, and imaging quality is affected. Thus, in the disclosure, by arranging the fourth spacer, restricting 0<d4s/(f4−f5)<0.5 and controlling an inner diameter of an object-side surface of the fourth spacer, an effective focal length of the fourth lens and an effective focal length of the fifth lens, the fourth spacer may be ensured to effectively block stray light generated at the fifth lens such that the stray light may be reduced and imaging quality may be improved.

### BRIEF DESCRIPTION OF THE DRAWINGS

Accompanying drawings of the description serve as a constituent part of the disclosure to provide a further understanding of the disclosure. Examples of the disclosure and their descriptions serve to explain the disclosure, and are not to be construed as unduly limiting the disclosure. In the accompanying drawings,

FIG. 1 shows a size annotation diagram of an optical imaging lens assembly according to an optional example of the disclosure.

FIG. 2 shows a schematic structural diagram of an optical imaging lens assembly according to Example 1-1 of the disclosure;

FIG. 3 shows a schematic structural diagram of an optical imaging lens assembly according to Example 1-2 of the disclosure;

FIG. 4 shows a schematic structural diagram of an optical imaging lens assembly according to Example 1-3 of the disclosure;

FIGS. 5 to 7 show a longitudinal aberration curve, an astigmatism curve and a distortion curve of an optical imaging lens assembly according to Example 1 of the disclosure respectively;

FIG. 8 shows a schematic structural diagram of an optical imaging lens assembly according to Example 2-1 of the disclosure;

FIG. 9 shows a schematic structural diagram of an optical imaging lens assembly according to Example 2-2 of the disclosure;

FIG. 10 shows a schematic structural diagram of an optical imaging lens assembly according to Example 2-3 of the disclosure;

FIGS. 11 to 13 show a longitudinal aberration curve, an astigmatism curve and a distortion curve of an optical imaging lens assembly according to Example 2 of the disclosure respectively;

FIG. 14 shows a schematic structural diagram of an optical imaging lens assembly according to Example 3-1 of the disclosure;

FIG. 15 shows a schematic structural diagram of an optical imaging lens assembly according to Example 3-2 of the disclosure;

FIG. 16 shows a schematic structural diagram of an optical imaging lens assembly according to Example 3-3 of the disclosure;

FIGS. 17 to 19 show a longitudinal aberration curve, an astigmatism curve and a distortion curve of an optical imaging lens assembly according to Example 3 of the disclosure respectively;

FIG. 20 shows a stray light diagram in a case that an optical imaging lens assembly in the disclosure satisfies EP45/CT5=1.9, R8/R9=1.9 and d4s/(f4−f5)=0.8;

FIG. 21 shows a stray light diagram in a case that an optical imaging lens assembly in the disclosure satisfies EP45/CT5=1.9, R8/R9=1.9 and d4s/(f4−f5)=0.36;

FIG. 22 shows a stray light diagram in a case that an optical imaging lens assembly in the disclosure satisfies EP45/CT5=2.7, R8/R9=2.0 and d4s/(f4−f5)=0.8;

FIG. 23 shows a stray light diagram in a case that an optical imaging lens assembly in the disclosure satisfies EP45/CT5=2.7, R8/R9=2.0 and d4s/(f4−f5)=−0.5; and

FIG. 24 shows a schematic diagram of an internal reflection optical path of an optical imaging lens assembly in the related art.

The above figures include reference numerals as follows:
P0. lens barrel, E1. first lens, S1. The object-side surface of the first lens, S2. image-side surface of the first lens, E2. second lens, S3. The object-side surface of the second lens, S4. image-side surface of the second lens, E3. third lens, S5. The object-side surface of the third lens, S6. image-side surface of the third lens, E4. fourth lens, S7. The object-side surface of the fourth lens, S8. image-side surface of the fourth lens, E5. fifth lens, S9. The object-side surface of the fifth lens, S10. image-side surface of the fifth lens, E6. sixth lens, S11. The object-side surface of the sixth lens, S12. image-side surface of the sixth lens, E7. seventh lens, S13. The object-side surface of seventh lens, S14. image-side surface of seventh lens, P1. first spacer, P2. second spacer, P3. third spacer, P4. fourth spacer, P5. fifth spacer, and P6. sixth spacer.

### DETAILED DESCRIPTION OF EMBODIMENTS

It should be noted that examples of the disclosure and features in the examples may be combined with one another if there is no conflict. The disclosure will be described in detail below with reference to accompanying drawings and in combination with examples.

It should be noted that all technical and scientific terms used in the disclosure have the same meanings as commonly understood by those of ordinary skill in the technical filed to which the disclosure belongs unless otherwise indicated.

In the disclosure, unless otherwise stated, orientational words such as “upper, lower, top, bottom” are generally used with respect to orientations shown in the accompanying drawings, or with respect to a vertical, perpendicular or gravitational orientation of a component itself. Similarly, for ease of understanding and description, the terms “inner and outer” refer to an inner and outer relative to a contour of each component itself. However, the above orientational words are not intended to limit the disclosure.

It should be noted that in the description, the expressions of the first, second, third, etc. are only used to distinguish one feature from another feature, and do not represent any limitation to the feature. Thus, a first lens discussed below could also be referred to as a second lens or a third lens without departing from the teachings of the disclosure.

In the accompanying drawings, a thickness, size and shape of a lens is slightly exaggerated for ease of description. Particularly, a spherical shape or an aspheric shape shown in the accompanying drawings is shown by way of instances. That is, the spherical shape or the aspheric shape is not limited to the spherical shape or the aspheric shape shown in the accompanying drawings. The accompanying drawings merely serve as instances, and are not drawn strictly to scale.

Herein, a paraxial region refers to a region near an optical axis. If a lens surface is a convex surface and a position of the convex surface is not defined, it is indicated that the lens surface is a convex surface in at least a paraxial region. If the lens surface is a concave surface and a position of the concave surface is not defined, it is indicated that the lens surface is a concave surface in at least a paraxial region. A surface type in the paraxial region may be determined through a determination method of a person having common general knowledge in the field. Whether the surface type is a concave surface or a convex surface is determined by using an R value (R refers to a a curvature radius of the paraxial region, and generally refers to an R value in a lens data base in optical software). A light-entering-side surface is determined as a convex surface in a case that the R value is positive and a concave surface in a case that the R value is negative. A light-emitting-side surface is determined as a concave surface in a case that the R value is positive and a convex surface in a case that the R value is negative.

In order to solve the problem of severe internally-reflected stray light on a seven-lens optical imaging lens assembly in the related art, the disclosure provides an optical imaging lens assembly.

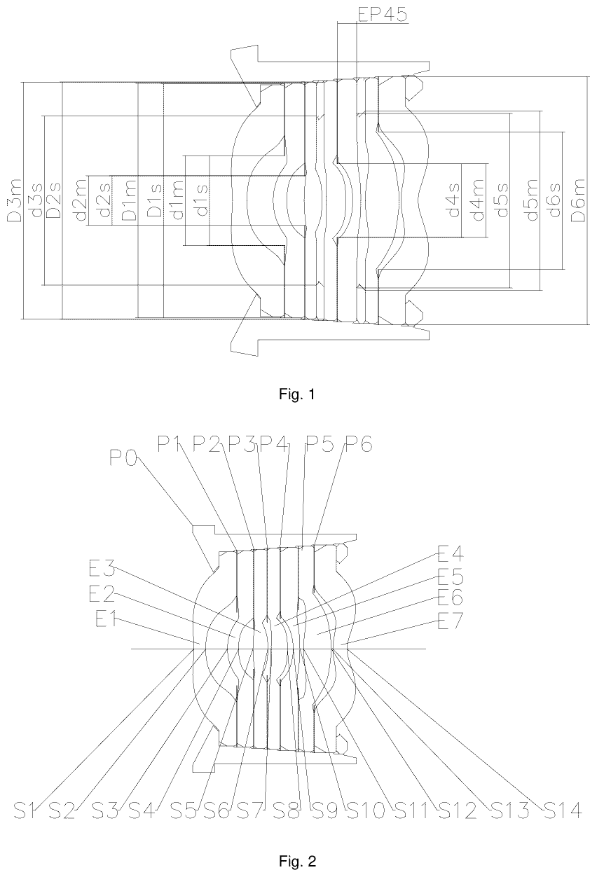

As shown in FIGS. 1 to 23, in an optional embodiment of the disclosure, an optical imaging lens assembly includes a lens barrel, seven lenses and a plurality of spacers. The seven lenses and the plurality of spacers are arranged in the lens barrel. The seven lenses include, in sequence from an object side to an image side, a first lens having negative refractive power, a second lens having positive refractive power, a third lens having positive refractive power, a fourth lens having positive refractive power, a fifth lens having negative refractive power, a sixth lens having positive refractive power and a seventh lens having negative refractive power. An air gap is provided between every two adjacent lenses of the first lens to the seventh lens. The plurality of spacers at least include a fourth spacer and a fifth spacer. The fourth spacer is located between the fourth lens and the fifth lens and abuts against part of an image-side surface of the fourth lens. The fifth spacer is located between the fifth lens and the sixth lens and abuts against part of an image-side surface of the fifth lens. A distance EP45 between an image-side surface of the fourth spacer and an object-side surface of the fifth spacer on an optical axis and a center thickness CT5 of the fifth lens satisfy: 1<EP45/CT5<4. A curvature radius R8 of the image-side surface of the fourth lens and a curvature radius R9 of an object-side surface of the fifth lens satisfy: 1<R8/R9<4. An inner diameter d4s of the object-side surface of the fourth spacer, an effective focal length f4 of the fourth lens and an effective focal length f5 of the fifth lens satisfy: 0<d4s/(f4−f5)<0.5.

The optical imaging lens assembly in the disclosure is composed of a lens barrel, and seven lenses and a plurality of spacers arranged in the lens barrel. The seven lenses and the plurality of spacers are reasonably arranged. A fourth lens having positive refractive power and a fifth lens having negative refractive power are arranged. In a case that the optical imaging lens assembly satisfies: 1<EP45/CT5<4 and 1<R8/R9<4, a refraction direction of light passing through the fourth lens and the fifth lens may be effectively controlled. Thus, an image height of each position of a field of view may be ensured and final imaging quality may be ensured. Moreover, as shown in FIG. 24, a schematic diagram of an internal reflection optical path of an optical imaging lens assembly in the related art is shown. It may be seen from the figure that incident light from an object side is likely to be internally reflected at an effective-radius edge of an image-side surface of the fifth lens, and the light is repeatedly reflected in an edge structure of the fifth lens, reaches an effective-radius edge of an object-side surface of the fifth lens and then is emitted, such that stray light is formed, and imaging quality is affected. Thus, in the disclosure, by arranging the fourth spacer, restricting 0<d4s/(f4−f5)<0.5 and controlling an inner diameter of an object-side surface of the fourth spacer, an effective focal length of the fourth lens and an effective focal length of the fifth lens, the fourth spacer may be ensured to effectively block stray light generated at the fifth lens such that the stray light may be reduced and imaging quality may be improved.

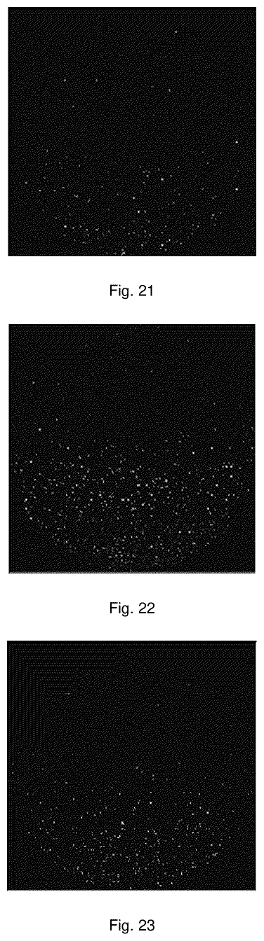

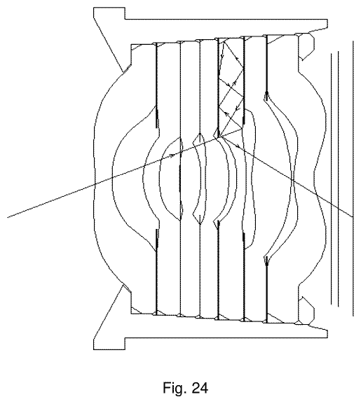

In addition, optical simulation is performed by changing relations between the inner diameter of the object-side surface of the fourth spacer, the effective focal length of the fourth lens and the effective focal length of the fifth lens. FIG. 20 shows a stray light diagram in a case that an optical imaging lens assembly satisfies EP45/CT5=1.9, R8/R9=1.9 and d4s/(f4−f5)=0.8. FIG. 21 shows a stray light diagram in a case that an optical imaging lens assembly satisfies EP45/CT5=1.9, R8/R9=1.9 and d4s/(f4−f5)=0.36. FIG. 22 shows a stray light diagram in a case that an optical imaging lens assembly satisfies EP45/CT5=2.7, R8/R9=2.0 and d4s/(f4−f5)=0.8. FIG. 23 shows a stray light diagram in a case that an optical imaging lens assembly satisfies EP45/CT5=2.7, R8/R9=2.0 and d4s/(f4−f5)=−0.5. It may be seen from FIG. 20 and FIG. 22 that stray light spots in the figures are obvious. It is indicated that stray light energy is higher. Through comparison, stray light spots in FIG. 21 are obviously reduced compared with those in FIG. 20, and stray light spots in FIG. 23 are obviously reduced compared with those in FIG. 22. Thus, by limiting 1<EP45/CT5<4, 1<R8/R9<4 and 0<d4s/(f4−f5)<0.5, stray light generated by the fifth lens may be effectively reduced, and stray light may be reduced.

In the embodiment, the plurality of spacers further include a first spacer and a second spacer. The first spacer is located between the first lens and the second lens and abuts against part of an image-side surface of the first lens. The second spacer is located between the second lens and the third lens and abuts against part of an image-side surface of the second lens. An inner diameter dis of an object-side surface of the first spacer, an inner diameter d2s of an object-side surface of the second spacer and an effective focal length f2 of the second lens satisfy: 2<f2/(d1s−d2s)<10. By restricting the conditional expression, an appearance difference of the optical imaging lens assembly may be distinguished, and each spacer may be ensured to be sequentially assembled with the lens barrel and each lens. Thus, assembly stability may be ensured. Moreover, by arranging the first spacer and the second spacer, stray light generated through reflection of the image-side surface of the first lens may be effectively prevented from entering the second lens. Thus, generation of ghost images may be reduced, and imaging quality of the optical imaging lens assembly may be improved.

In the embodiment, an inner diameter dim of an image-side surface of the first spacer, an outer diameter D1m of the image-side surface of the first spacer, and a distance T12 between the image-side surface of the first lens and an object-side surface of the second lens on the optical axis satisfy: 2<(D1m−d1m)/T12<6. By restricting the inner diameter of the image-side surface of the first spacer, the outer diameter of the image-side surface of the first spacer and the a distance between the image-side surface of the first lens and the object-side surface of the second lens on the optical axis, a position of light passing through the second lens may be effectively controlled. Thus, stray light reflected by the second lens may be reduced. Moreover, accuracy of a path of light passing through the second lens may be effectively ensured such that an image height of each field of view may be controlled to reach a required design position, and imaging quality may be ensured.

In the embodiment, an inner diameter d2s of an object-side surface of the second spacer, an inner diameter d2m of an image-side surface of the second spacer, a curvature radius R4 of the image-side surface of the second lens and a curvature radius R5 of an object-side surface of the third lens satisfy: −0.5<d2s/R4−d2m/R5<1. By restricting the curvature radii of the second lens and the third lens, surface types of the second lens and the third lens may be restricted. Thus, light may be transmitted along a predetermined optical path such that accuracy of a position of the light passing through the second lens and the third lens may be ensured. Moreover, by controlling the inner diameter of the object-side surface of the second spacer and the inner diameter of the image-side surface of the second spacer, the outer diameter of the second lens may be restricted. Thus, a size of the second lens may be effectively controlled for weight reduction such that total weight of the optical imaging lens assembly may be reduced for weight reduction. In addition, the stray light entering the third lens may be reduced by controlling the inner diameter of the image-side surface of the second spacer such that imaging quality may be improved.

In the embodiment, the plurality of spacers further include a third spacer. The third spacer is located between the third lens and the fourth lens and abuts against part of an image-side surface of the third lens. An inner diameter d3s of an object-side surface of the third spacer, an outer diameter D3m of an image-side surface of the third spacer, an effective focal length f3 of the third lens and an effective focal length f4 of the fourth lens satisfy: −5<(D3m−d3s)/(f4−f3)<15. By restricting the conditional expression, the outer diameter of the third lens may be controlled. Moreover, the inner diameter of the second spacer is controlled such that stray light entering the third lens may be reduced. The effective focal length of the third lens and the effective focal length of the fourth lens are restricted such that an overall length of a lens group close to an object-side end of the optical imaging lens assembly may be controlled. Thus, an overall length of the optical imaging lens assembly may be controlled such that miniaturization may be facilitated.

In the embodiment, an inner diameter d2m of an image-side surface of the second spacer, an effective diameter DT31 of a central light-transmitting region of an object-side surface of the third lens and an effective diameter DT22 of a central light-transmitting region of the image-side surface of the second lens satisfy: −18<d2m/(DT22−DT31)<8. By restricting the effective diameter of the central light-transmitting region of the image-side surface of the second lens and the effective diameter of the central light-transmitting region of the object-side surface of the third lens, light may be controlled to be transmitted in a rear-end lens group of the optical imaging lens assembly along a predetermined optical path. Thus, an image height of each field of view may be controlled to reach a required position. Moreover, the effective diameter of the second lens and the effective diameter of the third lens are indirectly controlled such that shape uniformity of each lens may be ensured. Thus, moldability and structural stability of the lens may be improved.

In the embodiment, an outer diameter D1s of an object-side surface of the first spacer, an outer diameter D2s of an object-side surface of the second spacer, an effective diameter DT12 of a central light-transmitting region of the image-side surface of the first lens and an effective diameter DT22 of a central light-transmitting region of the image-side surface of the second lens satisfy: 0<|D2s−D1s|/(DT12−DT22)<0.1. By restricting the conditional expression, an effective-diameter segment gap and an an outer diameter size of the first lens and the second lens may be controlled, and structural rationality of the first lens and the second lens may be ensured. In an embodiment mode, overall moldability and assembly stability of the lens may be improved such that a qualification rate of the optical imaging lens assembly in a production process may be improved. Moreover, an overall size of the lens barrel may be controlled and shape adaptability may be improved.

In the embodiment, an inner diameter d5s of the object-side surface of the fifth spacer, an inner diameter d4m of the image-side surface of the fourth spacer, a curvature radius R9 of the object-side surface of the fifth lens and a curvature radius R10 of the image-side surface of the fifth lens satisfy: 0<d5s/R10−d4m/R9<1.5. By restricting the a curvature radius of the object-side surface of the fifth lens and the a curvature radius of the image-side surface of the fifth lens, curvature of two side surfaces of the fifth lens may be restricted. Thus, reasonable distribution of optical power of the fifth lens may be effectively controlled such that accuracy of a path of light passing through the fifth lens may be ensured. Imaging quality of the optical imaging lens assembly may be improved, and an upper limit of a performance of the optical imaging lens assembly may be improved. Moreover, sizes of an inner diameters of the fourth spacer and the fifth spacer are controlled such that the fourth spacer and the fifth spacer may be ensured to effectively intercept stray light reflected thereto, and stray light generated due to spacer reflection may be avoided.

In the embodiment, the second spacer of the plurality of spacers, specifically, the first spacer to the sixth spacer, has a minimum inner diameter. In an embodiment mode, an inner diameter d1s of an object-side surface of the first spacer, an inner diameter d2s of an object-side surface of the second spacer and an inner diameter d3s of an object-side surface of the third spacer satisfy: 0<(d1s−d2s)/(d3s−d2s)<3. Through such an arrangement, sizes of the first spacer, the second spacer and the third spacer may be controlled. Moreover, the second spacer may be ensured to have the minimum inner diameter such that a difference in appearance of the spacers may be ensured. Since effective-diameter segment gaps of the first lens, the second lens and the third lens of the optical imaging lens assembly in the disclosure are large, by restricting the conditional expression, transition accuracy of an optical path of light from the first lens to the third lens may be ensured. Thus, differences between the effective diameters of the first lens, the second lens and the third lens may be reduced such that assembly stability of the optical imaging lens assembly may be ensured.

In the embodiment, an inner diameter d5s of the object-side surface of the fifth spacer, an inner diameter d5m of an image-side surface of the fifth spacer, an effective diameter DT52 of a central light-transmitting region of the image-side surface of the fifth lens and an effective diameter DT61 of a central light-transmitting region of an object-side surface of the sixth lens satisfy: 0<d5s/DT52−d5m/DT61<0.5. By restricting the conditional expression, a light height and a transmitted light amount of light passing through the fifth lens and the sixth lens may be controlled. Thus, an effective-diameter segment gap between the fifth lens and the sixth lens may be reduced, and a height difference between the light passing through the fifth lens and the sixth lens may be reasonably controlled such that stray light generated by the sixth lens may be effectively improved. Moreover, assembly stability of the fifth lens and the sixth lens may be improved such that overall structural stability of the optical imaging lens assembly may be ensured.

In the embodiment, the plurality of spacers further include a sixth spacer. The sixth spacer is located between the sixth lens and the seventh lens and abuts against part of an image-side surface of the sixth lens. An inner diameter d6s of an object-side surface of the sixth spacer, a center thickness CT6 of the sixth lens and a center thickness CT7 of the seventh lens satisfy: 2<d6s/(CT6+CT7)<5. By controlling the a center thicknesses of the sixth lens and the seventh lens within a reasonable range, structural strength of the sixth lens and the seventh lens may be ensured. Thus, formation of the lenses may be facilitated. Moreover, the inner diameter of the sixth spacer is controlled such that stray light generated due to reflection of the inner-diameter surface of the sixth spacer may be effectively avoided. A position of the light passing through the seventh lens may be effectively controlled such that a possibility that the seventh lens generates stray light is finally reduced. Accuracy of a path of imaging light passing through the last lens may be ensured and imaging stability may be ensured.

In the embodiment, an outer diameter D1s of an object-side surface of the first spacer, an outer diameter D6m of an image-side surface of the sixth spacer, an effective diameter DT11 of a central light-transmitting region of an object-side surface of the first lens and an effective diameter DT72 of a central light-transmitting region of an image-side surface of the seventh lens satisfy: 1.7<D1s/D6m+DT11/DT72<2.1. By restricting this conditional expression, effective-diameter segment gaps and outer-diameter segment gaps of the first lens to the seventh lens may be controlled. Since the central light-transmitting region of the object-side surface of the first lens and the central light-transmitting region of the image-side surface of the seventh lens of the optical imaging lens assembly in the disclosure have maximum an effective diameters, by controlling a segment gap of the effective diameters, an overall structural segment gap of the optical imaging lens assembly may be controlled. Thus, assembly stability of the optical imaging lens assembly may be ensured. Moreover, outer diameter sizes of two ends of the lens barrel are controlled such that an aperture difference of the two ends may be ensured to be not too large. Thus, a size of the optical imaging lens assembly may be ensured to be within a proper range such that instability caused by an over large size difference between a front end and a rear end of the optical imaging lens assembly may be avoided.

As shown in FIGS. 1 to 23, in another optional embodiment of the disclosure, the optical imaging lens assembly includes a lens barrel, seven lenses and a plurality of spacers. The seven lenses and the plurality of spacers are arranged in the lens barrel. The seven lenses include, in sequence from an object side to an image side, a first lens having negative refractive power, a second lens having positive refractive power, a third lens having positive refractive power, a fourth lens having positive refractive power, a fifth lens having negative refractive power, a sixth lens having positive refractive power and a seventh lens having negative refractive power. An air gap is provided between every two adjacent lenses of the first lens to the seventh lens. The plurality of spacers at least include a fourth spacer and a fifth spacer. The fourth spacer is located between the fourth lens and the fifth lens and abuts against part of an image-side surface of the fourth lens. The fifth spacer is located between the fifth lens and the sixth lens and abuts against part of an image-side surface of the fifth lens. A distance EP45 between an image-side surface of the fourth spacer and an object-side surface of the fifth spacer on an optical axis and a center thickness CT5 of the fifth lens satisfy: 1<EP45/CT5<4. A curvature radius R8 of the image-side surface of the fourth lens and a curvature radius R9 of an object-side surface of the fifth lens satisfy: 1<R8/R9<4. An inner diameter d5s of the object-side surface of the fifth spacer, an inner diameter d4m of the image-side surface of the fourth spacer, a curvature radius R9 of the object-side surface of the fifth lens and a curvature radius R10 of the image-side surface of the fifth lens satisfy: 0<d5s/R10−d4m/R9<1.5.

The optical imaging lens assembly in the disclosure is composed of a lens barrel, and seven lenses and a plurality of spacers arranged in the lens barrel. The seven lenses and the plurality of spacers are reasonably arranged. A fourth lens having positive refractive power and a fifth lens having negative refractive power are arranged. In a case that the optical imaging lens assembly satisfies: 1<EP45/CT5<4 and 1<R8/R9<4, a refraction direction of light passing through the fourth lens and the fifth lens may be effectively controlled. Thus, an image height of each position of a field of view may be ensured and final imaging quality may be ensured. However, light is likely to be internally reflected in the fifth lens, such that stray light is generated and imaging quality is affected. Thus, in the disclosure, by restricting 0<d5s/R10−d4m/R9<1.5, curvature of surfaces on two sides of the fifth lens may be restricted. Reasonable distribution of optical power of the fifth lens may be effectively controlled such that accuracy of a path of the light passing through the fifth lens may be ensured. In an embodiment mode, imaging quality of the optical imaging lens assembly may be improved such that an upper limit of a performance of the optical imaging lens assembly may be improved. Moreover, inner diameter sizes of the fourth spacer and the fifth spacer may be controlled such that the fourth spacer and the fifth spacer can effectively intercept stray light reflected thereto, and stray light generated due to spacer reflection may be prevented.

In an embodiment, the above optical imaging lens assembly may further include protective glass for protecting a photosensitive element located on an imaging surface.

A plurality of lenses, such as seven lenses as described above, may be used for the optical imaging lens assembly in the disclosure. In the disclosure, at least one of surfaces of each lens is an aspheric surface. An aspheric lens has a feature that curvature continuously varies from a center to a periphery of the lens. Different from a spherical lens having constant curvature from a center to a periphery of the lens, the aspheric lens has a better a curvature radius and can alleviate the problems of distortion aberration and astigmatism aberration. After the aspheric lens is used, aberration occurring during imaging may be eliminated as much as possible such that imaging quality may be improved.

In an embodiment, the above optical imaging lens assembly may further include a stop (not shown in the features) located between the second lens and the third lens.

However, those skilled in the art can understand that without departing from the claimed technical solution of the disclosure, a number of lenses constituting the optical imaging lens assembly may be varied such that various results and advantages described in the description may be obtained. For instance, although seven lenses are taken as an instance for description in the embodiment, the optical imaging lens assembly includes but is not limited to seven lenses. The optical imaging lens assembly may further include other numbers of lenses if desired.

FIG. 1 shows a schematic structural diagram of an optical imaging lens assembly according to the disclosure. Parameters such as EP45, D3m, d3s, D2s, d2m, d2s, D1m, D1s, d1m, d1s, d4s, d4m, d5s, d5m, d6s and D6m are indicated in FIG. 1 such that meanings of the parameters may be clearly and intuitively understood. In order to facilitate the optical imaging lens assembly and specific surface types, these parameters will not be embodied in accompanying drawings when particular examples are described subsequently.

Instances of specific surface types and parameters of the optical imaging lens assembly which may be suitable for the above embodiments will be further described below with reference to accompanying drawings.

It should be noted that three sub-examples exit in the same example described below. Parameters such as curvature radii and a center thicknesses of the first lens to the seventh lens of the optical imaging lens assembly, a distances between the lenses, and higher-order term coefficients in a plurality of sub-examples of the same example are the same, but parameters such as thicknesses, an inner diameters and an outer diameters of the lens barrel and the first spacer to the sixth spacer, and shapes of the lenses are different. In other words, primary structures for imaging are the same, while auxiliary structures for imaging are different.

It should be noted that any one of Examples 1 to 3 described below is suitable for all examples of the disclosure.

Certainly, other parameter formulas in the above embodiments will be also included in the embodiment and will not be repeated herein.

### Example 1

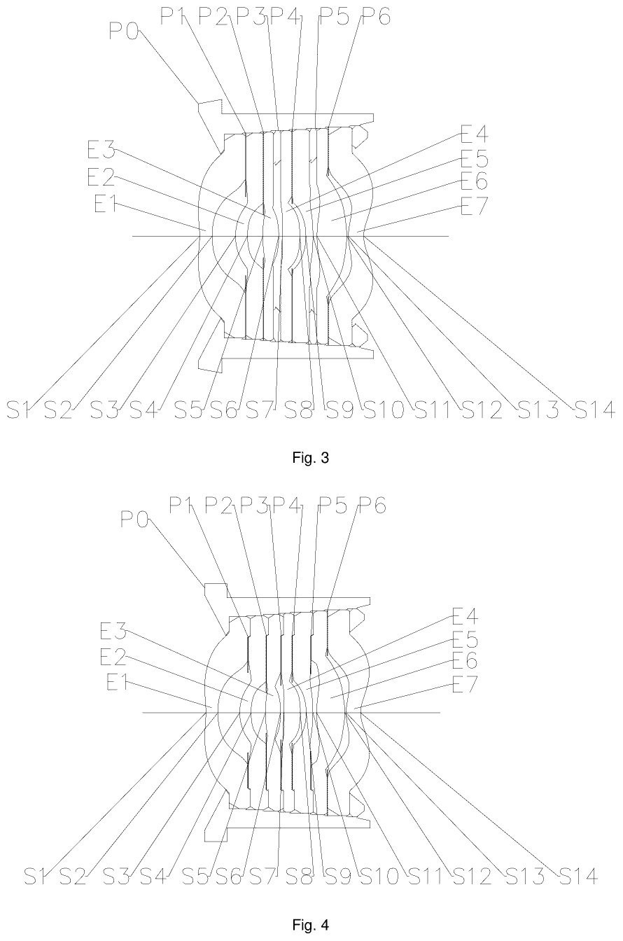

As shown in FIGS. 2 to 7, the optical imaging lens assembly of Example 1 is described. FIG. 2 shows a schematic structural diagram of the optical imaging lens assembly of Example 1 in Example 1-1. FIG. 3 shows a schematic structural diagram of the optical imaging lens assembly of Example 1 in Example 1-2. FIG. 4 shows a schematic structural diagram of the optical imaging lens assembly of Example 1 in Example 1-3.

As shown in FIGS. 2 to 4, the optical imaging lens assembly includes a lens barrel P0, and a first lens E1, a first spacer P1, a second lens E2, a second spacer P2, a third lens E3, a third spacer P3, a fourth lens E4, a fourth spacer P4, a fifth lens E5, a fifth spacer P5, a sixth lens E6, a sixth spacer P6 and a seventh lens E7 which are arranged in the lens barrel P0 in sequence from an object side to an image side along an optical axis of the lens barrel P0.

As shown in FIG. 2, in Example 1-1, an object-side surface and an image-side surface of the first spacer P1 of the optical imaging lens assembly abut against an image-side surface S2 of the first lens and an object-side surface S3 of the second lens respectively. An object-side surface and an image-side surface of the second spacer P2 abut against an image-side surface S4 of the second lens and an object-side surface S5 of the third lens respectively. An object-side surface and an image-side surface of the third spacer P3 abut against an image-side surface S6 of the third lens and an object-side surface S7 of the fourth lens respectively. An object-side surface and an image-side surface of the fourth spacer P4 abut against an image-side surface S8 of the fourth lens and an object-side surface S9 of the fifth lens respectively. An object-side surface and an image-side surface of the fifth spacer P5 abut against an image-side surface S10 of the fifth lens and an object-side surface S11 of the sixth lens respectively. An object-side surface and an image-side surface of the sixth spacer P6 abut against an image-side surface S12 of the sixth lens and an object-side surface S13 of the seventh lens respectively.

As shown in FIG. 3, in Example 1-2, an abutting manner of each spacer of the optical imaging lens assembly is the same as that in Example 1-1, may be obtained with reference to the relevant description in Example 1-1 and will not be repeated herein.

As shown in FIG. 4, in Example 1-3, an abutting manner of each spacer of the optical imaging lens assembly is the same as that in Example 1-1, may be obtained with reference to the relevant description in Example 1-1 and will not be repeated herein.

To sum up, structural parameters of the optical imaging lens assembly in Example 1 in cases of Example 1-1, Example 1-2 and Example 1-3 are shown in Table 1. (Unit: mm)

TABLE 1

| | Example | | |
|---|---|---|---|
| Parameter | 1-1 | 1-2 | 1-3 |
| d1s | 3.26 | 3.26 | 3.51 |
| d1m | 3.26 | 3.26 | 3.51 |
| D1s | 8.72 | 8.52 | 6.62 |
| D1m | 8.72 | 8.52 | 6.62 |
| d2s | 1.80 | 1.80 | 1.80 |
| d2m | 1.80 | 1.80 | 1.80 |
| D2s | 8.82 | 8.62 | 6.74 |
| d3s | 2.36 | 6.13 | 2.39 |
| D3m | 8.92 | 8.60 | 6.74 |
| d4s | 2.68 | 2.68 | 2.66 |
| d4m | 2.68 | 2.68 | 2.66 |
| d5s | 3.48 | 6.33 | 3.42 |
| d5m | 3.48 | 6.53 | 3.42 |
| d6s | 5.00 | 5.00 | 5.00 |
| D6m | 9.22 | 9.02 | 9.02 |
| EP45 | 0.80 | 0.72 | 0.83 |

In Example 1, the object-side surface S1 of the first lens is a concave surface, and the image-side surface S2 of the first lens is a concave surface. The object-side surface S3 of the second lens is a convex surface, and the image-side surface S4 of the second lens is a concave surface. The object-side surface S5 of the third lens is a convex surface, and the image-side surface S6 of the third lens is a convex surface. The object-side surface S7 of the fourth lens is a convex surface, and the image-side surface S8 of the fourth lens is a convex surface. The object-side surface S9 of the fifth lens is a concave surface, and the image-side surface S10 of the fifth lens is a convex surface. The object-side surface S11 of the sixth lens is a convex surface, and the image-side surface S12 of the sixth lens is a convex surface. The object-side surface S13 of the seventh lens is a convex surface, and the image-side surface S14 of the seventh lens is a concave surface.

In Example 1, the optical imaging lens assembly has an effective focal length f of 2.33 mm. The first lens has an effective focal length f1 of −3.87 mm. The second lens has an effective focal length f2 of 9.99 mm. The third lens has an effective focal length f3 of 4.69 mm. The fourth lens has an effective focal length f4 of 5.27 mm. The fifth lens has an effective focal length f5 of −5.17 mm. The sixth lens has an effective focal length f6 of 3.37 mm. The seventh lens has an effective focal length f7 of −5.76 mm. The optical imaging lens assembly has half of a maximum field of view (Semi-FOV) of 61.85°. The optical imaging lens assembly has an entrance pupil diameter (EPD) of 1.26 mm.

Table 2 shows a basic structural parameter table of the optical imaging lens assembly in Example 1. Units of a curvature radius and thickness/a distance are millimeter (mm).

TABLE 2

| | | | | Material | | |
|---|---|---|---|---|---|---|
| Surface | Surface | curvature | | Refractive | Abbe | Effective |
| number | type | radius | Thickness | index | number | radius |
| OBJ | Spherical | Infinity | Infinity | | | |
| | surface | | | | | |
| S1 | Aspheric | −3.7836 | 0.5381 | 1.54 | 56.11 | 3.3463 |
| | surface | | | | | |
| S2 | Aspheric | 5.0115 | 0.9860 | | | 2.0682 |
| | surface | | | | | |
| S3 | Aspheric | 2.0352 | 0.5103 | 1.59 | 28.41 | 1.4129 |
| | surface | | | | | |
| S4 | Aspheric | 1.8450 | 0.6677 | | | 1.1073 |
| | surface | | | | | |
| STO | Spherical | Infinity | −0.0170 | | | 0.8990 |
| | surface | | | | | |
| S5 | Aspheric | 5.0699 | 0.6780 | 1.54 | 56.11 | 0.9626 |
| | surface | | | | | |
| S6 | Aspheric | −4.9321 | 0.1514 | | | 1.1031 |
| | surface | | | | | |
| S7 | Aspheric | 7.4534 | 0.7436 | 1.54 | 56.11 | 1.2212 |
| | surface | | | | | |
| S8 | Aspheric | −4.5238 | 0.2631 | | | 1.3209 |
| | surface | | | | | |
| S9 | Aspheric | −2.2589 | 0.3000 | 1.67 | 19.24 | 1.3444 |
| | surface | | | | | |
| S10 | Aspheric | −6.7186 | 0.1686 | | | 1.6443 |
| | surface | | | | | |
| S11 | Aspheric | 113.4017 | 1.2687 | 1.54 | 56.11 | 2.0728 |
| | surface | | | | | |
| S12 | Aspheric | −2.9065 | 0.0685 | | | 2.4509 |
| | surface | | | | | |
| S13 | Aspheric | 2.1515 | 0.6465 | 1.66 | 20.37 | 2.5725 |
| | surface | | | | | |
| S14 | Aspheric | 1.2133 | 0.5637 | | | 3.3550 |
| | surface | | | | | |
| S15 | Spherical | Infinity | 0.2100 | 1.52 | 64.2 | 3.9583 |
| | surface | | | | | |
| S16 | Spherical | Infinity | 0.4970 | | | 4.0364 |
| | surface | | | | | |
| S17 | Spherical | Infinity | 0.0000 | | | 4.3468 |
| | surface | | | | | |

In Example 1, the object-side surfaces and the image-side surfaces of the first lens to the seventh lens are aspheric surfaces. A surface type of the aspheric lens may be defined by using a formula including but not limited to an aspheric formula as follows:

$$x = \frac{{ch}^{2}}{1 + \sqrt{1 - ( k + 1 ) {c}^{2} {h}^{2}}} + \sum {Aih}^{i} . \qquad formula ( 1 )$$

Specifically, x is a vector height of a a distance from an aspheric surface vertex in a case that an aspheric surface is located at a position having a height of h in an optical axis direction; c is a paraxial curvature of the aspheric surface, and c=1/R, that is, paraxial curvature c is an inverse of a curvature radius R in Table 2 described above; k is a cone coefficient; and Ai is a correction coefficient of an i-th order of the aspheric surface. Table 3 described below shows high-order term coefficients A4, A6, A8, A10, A12, A14, A16, A18, A20, A22, A24, A26, A28, and A30 which may be used for aspheric surfaces S1-S14 in Example 1.

TABLE 3

| Surface | | | | | | | |
|---|---|---|---|---|---|---|---|
| number | A4 | A6 | A8 | A10 | A12 | A14 | A16 |
| S1 | 2.6594E+00 | −4.3541E−01 | 1.6063E−01 | −6.1229E−02 | 2.4916E−02 | −1.2373E−02 | 4.8531E−03 |
| S2 | 8.5024E−01 | −1.0309E−01 | 3.5708E−03 | −2.6909E−02 | −2.4596E−03 | 1.2587E−04 | 1.9401E−03 |
| S3 | 6.5243E−02 | −2.0001E−02 | −1.5244E−02 | −5.6304E−03 | −3.6495E−04 | 4.7744E−04 | 3.2593E−04 |
| S4 | −1.2362E−01 | −6.0394E−03 | 1.1121E−02 | −3.5723E−03 | −5.8171E−04 | 1.1170E−03 | −6.1538E−04 |
| S5 | 3.8241E−03 | −3.7029E−04 | −3.9535E−05 | −1.4517E−05 | 5.1784E−06 | 3.9428E−06 | 6.5605E−06 |
| S6 | −1.0727E−01 | 9.9793E−03 | −7.8537E−04 | 1.5163E−04 | 7.0227E−05 | 1.1586E−05 | 3.4693E−05 |
| S7 | −1.4499E−01 | 1.4476E−02 | −1.3001E−03 | 1.3789E−04 | 5.1089E−05 | 4.5342E−05 | 2.5498E−05 |
| S8 | −2.4678E−01 | −1.0538E−02 | 5.9326E−03 | −7.4897E−04 | −2.1556E−04 | −1.2985E−04 | 2.1118E−06 |
| S9 | −2.0904E−01 | −7.9841E−03 | 2.7864E−03 | −8.5172E−04 | −7.9487E−05 | −6.0257E−04 | 7.1104E−06 |
| S10 | 5.7437E−02 | 2.6936E−02 | 2.9209E−04 | −3.4619E−03 | 1.8250E−03 | −1.4662E−03 | 6.3804E−04 |
| S11 | 3.9147E−01 | 5.0513E−02 | 2.6346E−02 | −1.2996E−02 | −6.9049E−03 | 2.1682E−03 | −4.0073E−03 |
| S12 | 3.0046E−01 | −1.4065E−01 | 7.1252E−02 | −3.9915E−02 | 5.2975E−03 | 3.9262E−03 | 9.0835E−04 |
| S13 | −2.7614E+00 | 3.9971E−01 | −1.7751E−02 | −3.3227E−03 | −4.1729E−04 | 5.4141E−03 | −1.2554E−04 |
| S14 | −5.8070E+00 | 1.0282E+00 | −3.1258E−01 | 1.1366E−01 | −4.4172E−02 | 2.1417E−02 | −8.6059E−03 |
| Surface | | | | | | | |
| number | A18 | A20 | A22 | A24 | A26 | A28 | A30 |
| S1 | −2.9529E−03 | 1.0829E−03 | −6.7892E−04 | 2.9586E−04 | −1.1272E−04 | 5.9200E−05 | 0.0000E+00 |
| S2 | 8.4804E−04 | 1.5601E−04 | −4.3822E−05 | −8.9457E−05 | 0.0000E+00 | 0.0000E+00 | 0.0000E+00 |
| S3 | 4.4456E−05 | −2.2203E−05 | −2.3284E−05 | 9.1131E−06 | 9.0126E−06 | 7.1492E−06 | −4.2674E−06 |
| S4 | 1.9730E−04 | −5.8748E−05 | 2.9735E−05 | 1.6853E−05 | −2.8426E−05 | −7.3644E−06 | 0.0000E+00 |
| S5 | 3.2343E−07 | −1.6975E−06 | −1.9084E−06 | 2.1437E−07 | 1.6223E−07 | 0.0000E+00 | 0.0000E+00 |
| S6 | 6.1361E−07 | 1.8528E−05 | −2.3736E−06 | 2.2135E−06 | −7.1402E−06 | 1.9978E−06 | 0.0000E+00 |
| S7 | 2.8577E−05 | 1.4222E−06 | 1.5661E−06 | 2.3974E−08 | −1.8757E−06 | −1.5891E−06 | 7.0563E−07 |
| S8 | 4.0307E−05 | 2.7099E−05 | 9.4473E−06 | 3.7799E−07 | 2.5009E−06 | −2.8508E−06 | 2.9526E−07 |
| S9 | 3.8089E−05 | 4.3316E−05 | −7.8206E−06 | −5.0576E−06 | 6.9077E−07 | 8.1432E−09 | 1.3163E−07 |
| S10 | −1.2764E−04 | 8.1775E−05 | −6.5188E−05 | 1.7314E−05 | −8.9441E−06 | 6.7877E−06 | −1.4434E−06 |
| S11 | 3.3578E−04 | −7.7620E−04 | −4.7965E−04 | −3.3754E−04 | −1.2226E−04 | 4.8394E−05 | 0.0000E+00 |
| S12 | −2.9663E−04 | 3.0206E−04 | −2.0540E−04 | 1.4477E−04 | −7.5142E−05 | 0.0000E+00 | 0.0000E+00 |
| S13 | −1.3558E−03 | 3.2892E−04 | −4.5779E−04 | 1.6679E−04 | 6.5093E−06 | 0.0000E+00 | 0.0000E+00 |
| S14 | 4.3852E−03 | −2.2585E−03 | 7.8283E−04 | −2.5618E−04 | 1.3707E−04 | −6.3825E−05 | 1.1526E−05 |

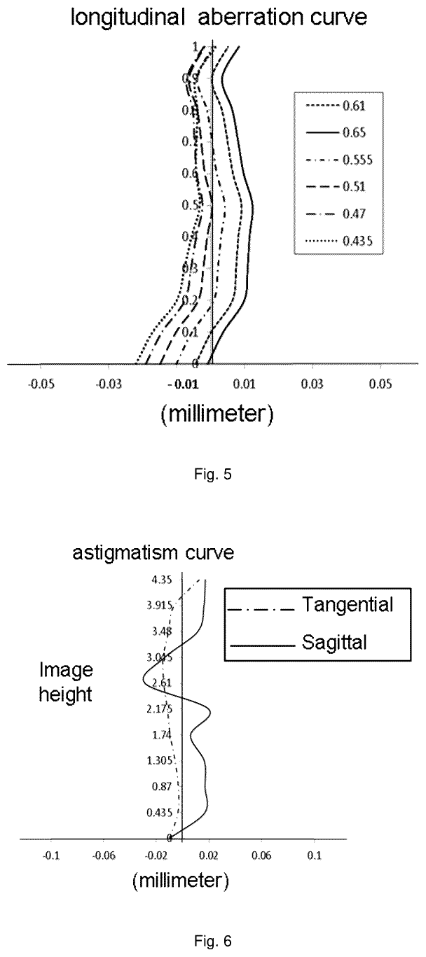

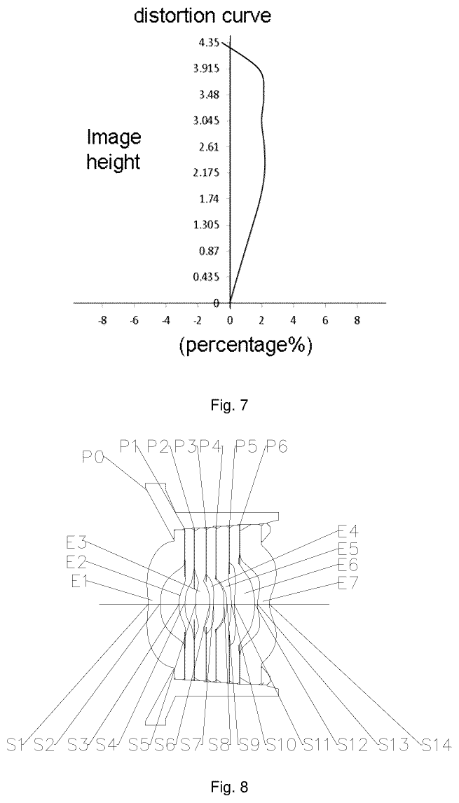

FIG. 5 shows a longitudinal aberration curve of the optical imaging lens assembly in Example 1. The longitudinal aberration curve represents that a convergence focus of light having different wavelengths will be deviated after the light passes through the optical imaging lens assembly. FIG. 6 shows an astigmatism curve of the optical imaging lens assembly in Example 1. The astigmatism curve represents curvature of a tangential image surface and a sagittal image surface. FIG. 7 shows a distortion curve of the optical imaging lens assembly in Example 1. The distortion curve represents distortion magnitude values corresponding to different angles of view.

According to FIGS. 5 to 7, it may be known that the optical imaging lens assembly provided in Example 1 can achieve desirable imaging quality.

### Example 2

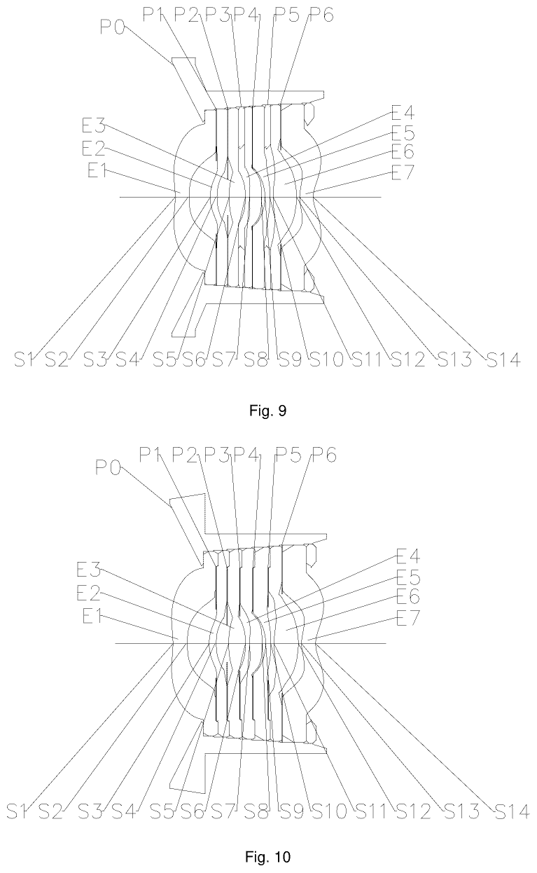

As shown in FIGS. 8 to 13, an optical imaging lens assembly of Example 2 is described. FIG. 8 shows a schematic structural diagram of the optical imaging lens assembly of Example 2 in Example 2-1. FIG. 9 shows a schematic structural diagram of the optical imaging lens assembly of Example 2 in Example 2-2. FIG. 10 shows a schematic structural diagram of the optical imaging lens assembly of Example 2 in Example 2-3.

As shown in FIGS. 8 to 10, the optical imaging lens assembly includes a lens barrel P0, and a first lens E1, a first spacer P1, a second lens E2, a second spacer P2, a third lens E3, a third spacer P3, a fourth lens E4, a fourth spacer P4, a fifth lens E5, a fifth spacer P5, a sixth lens E6, a sixth spacer P6 and a seventh lens E7 which are arranged in the lens barrel P0 in sequence from an object side to an image side along an optical axis of the lens barrel P0.

As shown in FIG. 8, in Example 2-1, an object-side surface and an image-side surface of the first spacer P1 of the optical imaging lens assembly abut against an image-side surface S2 of the first lens and an object-side surface S3 of the second lens respectively. An object-side surface and an image-side surface of the second spacer P2 abut against an image-side surface S4 of the second lens and an object-side surface S5 of the third lens respectively. An object-side surface and an image-side surface of the third spacer P3 abut against an image-side surface S6 of the third lens and an object-side surface S7 of the fourth lens respectively. An object-side surface and an image-side surface of the fourth spacer P4 abut against an image-side surface S8 of the fourth lens and an object-side surface S9 of the fifth lens respectively. An object-side surface and an image-side surface of the fifth spacer P5 abut against an image-side surface S10 of the fifth lens and an object-side surface S11 of the sixth lens respectively. An object-side surface and an image-side surface of the sixth spacer P6 abut against an image-side surface S12 of the sixth lens and an object-side surface S13 of the seventh lens respectively.

As shown in FIG. 9, in Example 2-2, an abutting manner of each spacer of the optical imaging lens assembly is the same as that in Example 2-1, may be obtained with reference to the relevant description in Example 2-1 and will not be repeated herein.

As shown in FIG. 10, in Example 2-3, an abutting manner of each spacer of the optical imaging lens assembly is the same as that in Example 2-1, may be obtained with reference to the relevant description in Example 2-1 and will not be repeated herein.

To sum up, structural parameters of the optical imaging lens assembly in Example 2 in cases of Example 2-1, Example 2-2 and Example 2-3 are shown in Table 4. (Unit: mm)

TABLE 4

| | Example | | |
|---|---|---|---|
| Parameter | 2-1 | 2-2 | 2-3 |
| d1s | 3.22 | 3.65 | 3.31 |
| d1m | 3.22 | 3.65 | 3.31 |
| D1s | 8.72 | 8.82 | 7.44 |
| D1m | 8.72 | 8.82 | 7.44 |
| d2s | 1.81 | 1.81 | 1.81 |
| d2m | 1.81 | 1.81 | 1.81 |
| D2s | 8.82 | 8.92 | 7.40 |
| d3s | 2.66 | 5.09 | 2.63 |
| D3m | 8.92 | 8.84 | 7.30 |
| d4s | 2.90 | 2.90 | 3.08 |
| d4m | 2.90 | 2.90 | 3.08 |
| d5s | 3.56 | 5.08 | 3.53 |
| d5m | 3.56 | 5.28 | 3.53 |
| d6s | 4.71 | 4.71 | 4.80 |
| D6m | 9.22 | 9.32 | 9.52 |
| EP45 | 0.76 | 0.61 | 0.75 |

In Example 2, the object-side surface S1 of the first lens is a concave surface, and the image-side surface S2 of the first lens is a concave surface. The object-side surface S3 of the second lens is a convex surface, and the image-side surface S4 of the second lens is a concave surface. The object-side surface S5 of the third lens is a convex surface, and the image-side surface S6 of the third lens is a convex surface. The object-side surface S7 of the fourth lens is a convex surface, and the image-side surface S8 of the fourth lens is a convex surface. The object-side surface S9 of the fifth lens is a concave surface, and the image-side surface S10 of the fifth lens is a convex surface. The object-side surface S11 of the sixth lens is a convex surface, and the image-side surface S12 of the sixth lens is a convex surface. The object-side surface S13 of the seventh lens is a convex surface, and the image-side surface S14 of the seventh lens is a concave surface.

In Example 2, the optical imaging lens assembly has an effective focal length f of 2.33 mm. The first lens has an effective focal length f1 of −4.27 mm. The second lens has an effective focal length f2 of 10.97 mm. The third lens has an effective focal length f3 of 4.30 mm. The fourth lens has an effective focal length f4 of 6.05 mm. The fifth lens has an effective focal length f5 of −4.30 mm. The sixth lens has an effective focal length f6 of 3.46 mm. The seventh lens has an effective focal length f7 of −7.81 mm. The optical imaging lens assembly has half of a maximum field of view (Semi-FOV) of 61.830. The optical imaging lens assembly has an entrance pupil diameter (EPD) of 1.26 mm.

Table 5 shows a basic structural parameter table of the optical imaging lens assembly in Example 2. Units of a curvature radius and thickness/a distance are millimeter (mm).

TABLE 5

| | | | | Material | | |
|---|---|---|---|---|---|---|
| Surface | Surface | curvature | | Refractive | Abbe | Effective |
| number | type | radius | Thickness | index | number | radius |
| OBJ | Spherical | Infinity | Infinity | | | |
| | surface | | | | | |
| S1 | Aspheric | −3.8062 | 0.7132 | 1.54 | 55.92 | 3.6532 |
| | surface | | | | | |
| S2 | Aspheric | 6.3972 | 1.0828 | | | 2.2225 |
| | surface | | | | | |
| S3 | Aspheric | 2.1251 | 0.3500 | 1.58 | 38.32 | 1.3938 |
| | surface | | | | | |
| S4 | Aspheric | 2.9701 | 0.5438 | | | 1.1440 |
| | surface | | | | | |
| STO | Spherical | Infinity | 0.0730 | | | 0.8917 |
| | surface | | | | | |
| S5 | Aspheric | 4.5278 | 0.8360 | 1.54 | 55.92 | 1.1947 |
| | surface | | | | | |
| S6 | Aspheric | −4.5629 | 0.2139 | | | 1.3043 |
| | surface | | | | | |
| S7 | Aspheric | 5.8783 | 0.6131 | 1.54 | 55.92 | 1.3698 |
| | surface | | | | | |
| S8 | Aspheric | −7.2578 | 0.1823 | | | 1.4485 |
| | surface | | | | | |
| S9 | Aspheric | −1.9215 | 0.2500 | 1.67 | 19.24 | 1.4492 |
| | surface | | | | | |
| S10 | Aspheric | −5.9391 | 0.1645 | | | 1.7176 |
| | surface | | | | | |
| S11 | Aspheric | 4.6077 | 1.2040 | 1.54 | 55.92 | 2.0944 |
| | surface | | | | | |
| S12 | Aspheric | −2.9002 | 0.1607 | | | 2.3260 |
| | surface | | | | | |
| S13 | Aspheric | 2.0901 | 0.6941 | 1.67 | 19.24 | 2.4658 |
| | surface | | | | | |
| S14 | Aspheric | 1.2969 | 0.5518 | | | 3.3470 |
| | surface | | | | | |
| S15 | Spherical | Infinity | 0.2100 | 1.52 | 64.2 | 3.9528 |
| | surface | | | | | |
| S16 | Spherical | Infinity | 0.4851 | | | 4.0330 |
| | surface | | | | | |
| S17 | Spherical | Infinity | 0.0000 | | | 4.3469 |
| | surface | | | | | |

Table 6 described below shows high-order term coefficients A4, A6, A8, A10, A12, A14, A16, A18, A20, A22, A24, A26, A28 and A30 which may be used for aspheric surfaces S1-S14 in Example 2.

TABLE 6

| Surface | | | | | | | |
|---|---|---|---|---|---|---|---|
| number | A4 | A6 | A8 | A10 | A12 | A14 | A16 |
| S1 | 3.6719E+00 | −3.9398E−01 | 2.5009E−01 | −2.6750E−02 | 4.7635E−02 | 1.7638E−03 | 1.3044E−02 |
| S2 | 1.0974E+00 | −1.5020E−01 | 6.5656E−03 | −1.7923E−02 | −3.0898E−03 | −8.7509E−04 | 1.5866E−03 |
| S3 | 2.5175E−03 | −4.0018E−02 | −1.4500E−03 | 1.3114E−03 | −1.4191E−04 | −3.0513E−04 | −7.5429E−06 |
| S4 | 5.5331E−02 | −1.6594E−03 | 1.0628E−03 | 8.5652E−04 | 1.6498E−04 | −1.7816E−05 | −2.0640E−05 |
| S5 | 3.2827E−02 | −9.2536E−04 | −6.9085E−04 | −1.8696E−04 | 1.5985E−05 | 4.7090E−05 | 1.6346E−05 |
| S6 | −1.3706E−01 | 1.6250E−02 | −3.4758E−03 | −9.1129E−04 | −2.1922E−04 | 4.2633E−05 | 8.7131E−05 |
| S7 | −2.4964E−01 | 4.8163E−03 | 1.4834E−03 | −1.4117E−03 | 5.2483E−04 | 4.6339E−04 | 1.2556E−04 |
| S8 | −3.4023E−01 | −1.8598E−02 | 1.4344E−02 | −3.3266E−04 | 2.4474E−03 | 1.5142E−03 | 2.2645E−05 |
| S9 | −2.5033E−01 | −1.1038E−02 | −3.5992E−03 | −6.6567E−04 | 3.4837E−03 | 7.2346E−04 | −6.5116E−05 |
| S10 | 6.2662E−02 | 2.5992E−02 | −1.0840E−03 | −4.7407E−03 | 5.0148E−03 | −2.3718E−03 | 1.0236E−03 |
| S11 | −5.5608E−01 | 4.9421E−02 | 2.2779E−02 | −2.4072E−02 | 2.6036E−03 | −6.2883E−04 | 1.9946E−03 |
| S12 | 1.5550E−01 | −2.5002E−02 | 6.3524E−02 | −3.4166E−02 | −1.2172E−02 | −5.5839E−04 | 4.8377E−03 |
| S13 | −2.6431E+00 | 3.2931E−01 | 4.1382E−03 | −2.8016E−03 | −2.5181E−03 | −4.2958E−04 | 3.3682E−03 |
| S14 | −5.4295E+00 | 9.0913E−01 | −2.6473E−01 | 9.4578E−02 | −3.1915E−02 | 1.3939E−02 | −2.5538E−03 |
| Surface | | | | | | | |
| number | A18 | A20 | A22 | A24 | A26 | A28 | A30 |
| S1 | 2.6378E−03 | 4.0899E−03 | 1.2282E−03 | 1.1789E−03 | 3.8729E−04 | 2.4407E−04 | 5.8870E−05 |
| S2 | 1.4436E−03 | 4.6982E−04 | −8.4223E−05 | −2.9145E−04 | −8.4884E−05 | −8.5521E−06 | 3.3687E−05 |
| S3 | 7.5112E−05 | 2.4086E−05 | 3.7699E−06 | 9.1488E−06 | 1.6361E−06 | −2.5324E−06 | −1.4303E−07 |
| S4 | 8.7697E−06 | −7.2490E−06 | −1.9652E−06 | 8.3918E−07 | 0.0000E+00 | 0.0000E+00 | 0.0000E+00 |
| S5 | 9.5978E−06 | −6.5613E−06 | 0.0000E+00 | 0.0000E+00 | 0.0000E+00 | 0.0000E+00 | 0.0000E+00 |
| S6 | 4.8121E−05 | 3.3059E−05 | 8.5415E−06 | 1.7319E−07 | −5.1031E−06 | 4.1642E−07 | 0.0000E+00 |
| S7 | −3.3614E−06 | −3.4746E−05 | −6.5736E−06 | −6.6521E−06 | 2.7183E−06 | −1.7536E−06 | 7.8543E−07 |
| S8 | −1.8949E−04 | 9.8447E−06 | −2.3943E−05 | −5.3738E−05 | −7.2808E−06 | −7.6783E−06 | 7.5542E−06 |
| S9 | −4.4656E−04 | 5.0578E−05 | 1.9308E−06 | −2.5445E−05 | 2.6379E−05 | −5.4651E−06 | 0.0000E+00 |
| S10 | −5.8872E−04 | 3.4940E−04 | −1.4546E−04 | 5.8173E−05 | −1.4405E−05 | 0.0000E+00 | 0.0000E+00 |
| S11 | −1.3816E−03 | 6.7038E−04 | −1.2426E−04 | 1.1262E−04 | −9.7402E−05 | 3.8369E−05 | −8.0400E−06 |
| S12 | 5.2771E−04 | −9.6470E−05 | −2.5074E−04 | −2.0128E−06 | 3.9676E−05 | 5.4460E−05 | −3.1498E−05 |
| S13 | −9.7517E−05 | 5.1078E−04 | 2.6492E−04 | −4.5727E−04 | −2.8773E−04 | 4.0389E−05 | 5.7543E−05 |
| S14 | 1.8000E−03 | 5.2465E−04 | 4.1474E−05 | −3.1751E−04 | −9.6018E−05 | −1.0861E−04 | 7.0639E−05 |

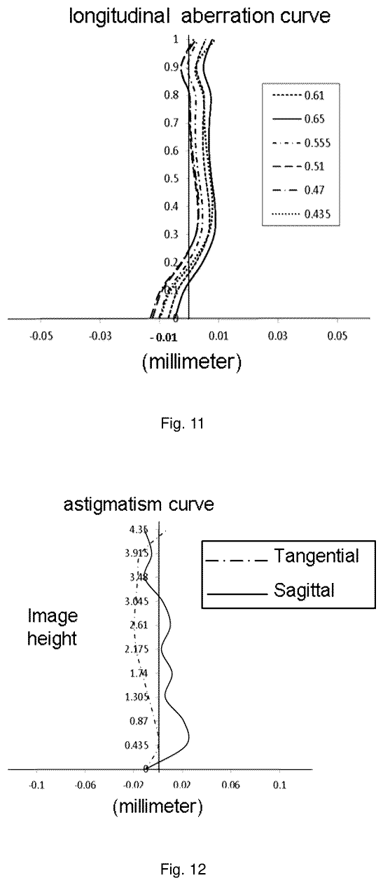

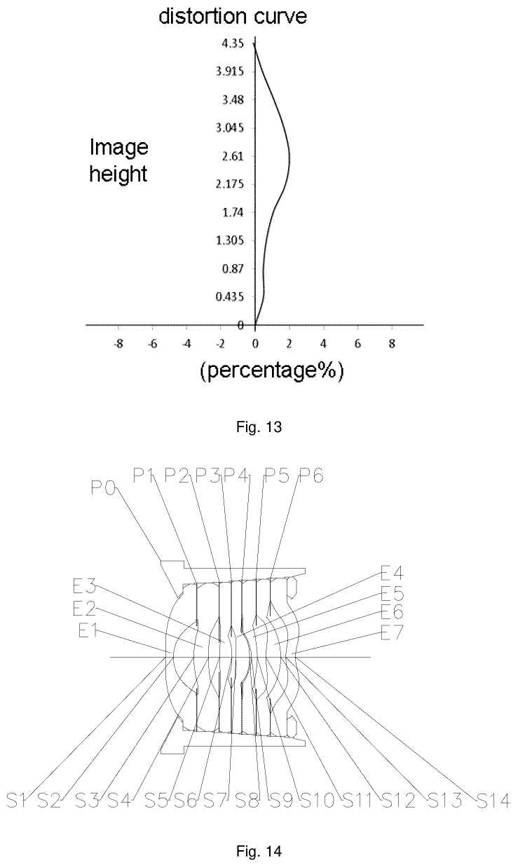

FIG. 11 shows a longitudinal aberration curve of the optical imaging lens assembly in Example 2. The longitudinal aberration curve represents that a convergence focus of light having different wavelengths will be deviated after the light passes through the optical imaging lens assembly. FIG. 12 shows an astigmatism curve of the optical imaging lens assembly in Example 2. The astigmatism curve represents curvature of a tangential image surface and a sagittal image surface. FIG. 13 shows a distortion curve of the optical imaging lens assembly in Example 2. The distortion curve represents distortion magnitude values corresponding to different angles of view.

According to FIGS. 11 to 13, it may be known that the optical imaging lens assembly provided in Example 2 can achieve desirable imaging quality.

### Example 3

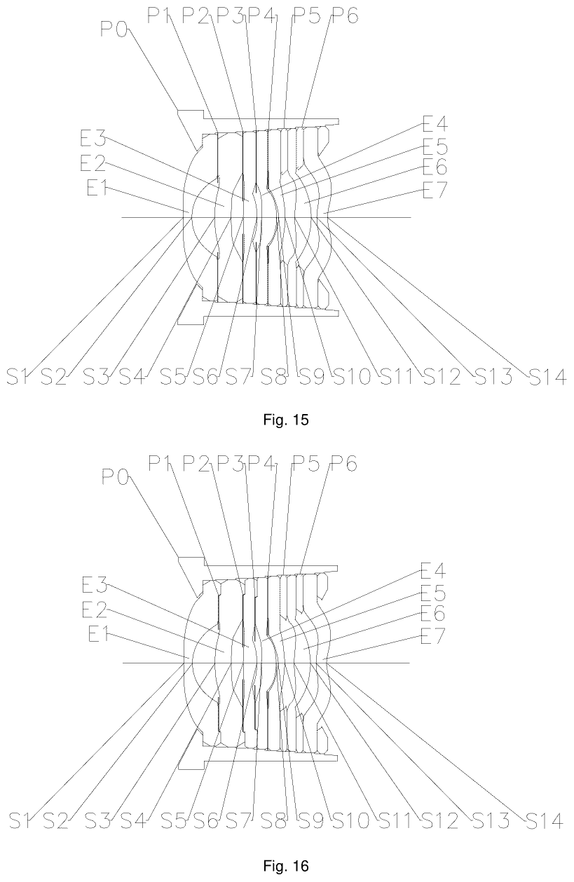

As shown in FIGS. 14 to 19, an optical imaging lens assembly of Example 3 is described. FIG. 14 shows a schematic structural diagram of the optical imaging lens assembly of Example 3 in Example 3-1. FIG. 15 shows a schematic structural diagram of the optical imaging lens assembly of Example 3 in Example 3-2. FIG. 16 shows a schematic structural diagram of the optical imaging lens assembly of Example 3 in Example 3-3.

As shown in FIGS. 14 to 16, the optical imaging lens assembly includes a lens barrel P0, and a first lens E1, a first spacer P1, a second lens E2, a second spacer P2, a third lens E3, a third spacer P3, a fourth lens E4, a fourth spacer P4, a fifth lens E5, a fifth spacer P5, a sixth lens E6, a sixth spacer P6 and a seventh lens E7 which are arranged in the lens barrel P0 in sequence from an object side to an image side along an optical axis of the lens barrel P0.

As shown in FIG. 14, in Example 3-1, an object-side surface and an image-side surface of the first spacer P1 of the optical imaging lens assembly abut against an image-side surface S2 of the first lens and an object-side surface S3 of the second lens respectively. An object-side surface and an image-side surface of the second spacer P2 abut against an image-side surface S4 of the second lens and an object-side surface S5 of the third lens respectively. An object-side surface and an image-side surface of the third spacer P3 abut against an image-side surface S6 of the third lens and an object-side surface S7 of the fourth lens respectively. An object-side surface and an image-side surface of the fourth spacer P4 abut against an image-side surface S8 of the fourth lens and an object-side surface S9 of the fifth lens respectively. An object-side surface and an image-side surface of the fifth spacer P5 abut against an image-side surface S10 of the fifth lens and an object-side surface S11 of the sixth lens respectively. An object-side surface and an image-side surface of the sixth spacer P6 abut against an image-side surface S12 of the sixth lens and an object-side surface S13 of the seventh lens respectively.

As shown in FIG. 15, in Example 3-2, an abutting manner of each spacer of the optical imaging lens assembly is the same as that in Example 3-1, may be obtained with reference to the relevant description in Example 3-1 and will not be repeated herein.

As shown in FIG. 16, in Example 3-3, an abutting manner of each spacer of the optical imaging lens assembly is the same as that in Example 3-1, may be obtained with reference to the relevant description in Example 3-1 and will not be repeated herein.

To sum up, structural parameters of the optical imaging lens assembly in Example 3 in cases of Example 3-1, Example 3-2 and Example 3-3 are shown in Table 7. (Unit: mm)

TABLE 7

| | Example | | |
|---|---|---|---|
| Parameter | 3-1 | 3-2 | 3-3 |
| d1s | 3.14 | 3.14 | 3.09 |
| d1m | 3.14 | 3.14 | 3.09 |
| D1s | 7.44 | 7.64 | 6.17 |
| D1m | 7.44 | 7.64 | 6.17 |
| d2s | 1.48 | 1.48 | 1.48 |
| d2m | 1.48 | 1.48 | 1.48 |
| D2s | 7.54 | 7.74 | 6.23 |
| d3s | 2.07 | 2.24 | 2.02 |
| D3m | 7.64 | 7.84 | 5.99 |
| d4s | 2.51 | 2.58 | 2.58 |
| d4m | 2.51 | 2.58 | 2.58 |
| d5s | 3.20 | 4.11 | 4.40 |
| d5m | 3.20 | 4.31 | 4.31 |
| d6s | 4.16 | 4.57 | 4.98 |
| D6m | 7.94 | 7.96 | 7.97 |
| EP45 | 0.72 | 0.57 | 0.57 |

In Example 3, the object-side surface S1 of the first lens is a concave surface, and the image-side surface S2 of the first lens is a concave surface. The object-side surface S3 of the second lens is a convex surface, and the image-side surface S4 of the second lens is a concave surface. The object-side surface S5 of the third lens is a convex surface, and the image-side surface S6 of the third lens is a convex surface. The object-side surface S7 of the fourth lens is a convex surface, and the image-side surface S8 of the fourth lens is a convex surface. The object-side surface S9 of the fifth lens is a concave surface, and the image-side surface S10 of the fifth lens is a convex surface. The object-side surface S11 of the sixth lens is a convex surface, and the image-side surface S12 of the sixth lens is a convex surface. The object-side surface S13 of the seventh lens is a convex surface, and the image-side surface S14 of the seventh lens is a concave surface.

In Example 3, the optical imaging lens assembly has an effective focal length f of 1.98 mm. The first lens has an effective focal length f1 of −3.21 mm. The second lens has an effective focal length f2 of 7.59 mm. The third lens has an effective focal length f3 of 5.05 mm. The fourth lens has an effective focal length f4 of 3.69 mm. The fifth lens has an effective focal length f5 of −3.41 mm. The sixth lens has an effective focal length f6 of 3.17 mm. The seventh lens has an effective focal length f7 of −12.91 mm. The optical imaging lens assembly has half of a maximum field of view (Semi-FOV) of 62.27°. The optical imaging lens assembly has an entrance pupil diameter (EPD) of 1.00 mm.

Table 8 shows a basic structural parameter table of the optical imaging lens assembly in Example 3. Units of a curvature radius and thickness/a distance are all millimeter (mm).

TABLE 8

| | | | | Material | | |
|---|---|---|---|---|---|---|
| Surface | Surface | A curvature | | Refractive | Abbe | Effective |
| number | type | radius | Thickness | index | number | radius |
| OBJ | Spherical | Infinity | Infinity | | | |
| | surface | | | | | |
| S1 | Aspheric | −14.1061 | 0.4000 | 1.54 | 56.11 | 2.8738 |
| | surface | | | | | |
| S2 | Aspheric | 2.0243 | 1.0508 | | | 1.7211 |
| | surface | | | | | |
| S3 | Aspheric | 4.1166 | 0.7666 | 1.67 | 19.40 | 1.4714 |
| | surface | | | | | |
| S4 | Aspheric | 19.1951 | 0.5539 | | | 1.1329 |
| | surface | | | | | |
| STO | Spherical | Infinity | 0.0085 | | | 0.7441 |
| | surface | | | | | |
| S5 | Aspheric | 9.5113 | 0.6379 | 1.54 | 56.00 | 0.7814 |
| | surface | | | | | |
| S6 | Aspheric | −3.1245 | 0.2131 | | | 0.9744 |
| | surface | | | | | |
| S7 | Aspheric | 7.2218 | 0.6952 | 1.54 | 56.00 | 1.1154 |
| | surface | | | | | |
| S8 | Aspheric | −2.7027 | 0.0959 | | | 1.2411 |
| | surface | | | | | |
| S9 | Aspheric | −1.4278 | 0.3000 | 1.67 | 19.40 | 1.2722 |
| | surface | | | | | |
| S10 | Aspheric | −4.0741 | 0.4517 | | | 1.5002 |
| | surface | | | | | |
| S11 | Aspheric | 4.5391 | 0.7619 | 1.54 | 56.11 | 1.8076 |
| | surface | | | | | |
| S12 | Aspheric | −2.6321 | 0.2605 | | | 1.9672 |
| | surface | | | | | |
| S13 | Aspheric | 2.2831 | 0.4969 | 1.67 | 19.40 | 2.2767 |
| | surface | | | | | |
| S14 | Aspheric | 1.6510 | 1.2258 | | | 2.6784 |
| | surface | | | | | |
| S15 | Spherical | Infinity | 0.2100 | 1.52 | 64.2 | 6.0500 |
| | surface | | | | | |
| S16 | Spherical | Infinity | 0.4719 | | | 6.0500 |
| | surface | | | | | |
| S17 | Spherical | Infinity | 0.0000 | | | 4.3600 |
| | surface | | | | | |

Table 9 described below shows high-order term coefficients A4, A6, A8, A10, A12, A14, A16, A18, A20, A22, A24, A26, A28, and A30 which may be used for aspheric surfaces S1-S14 in Example 3.

TABLE 9

| Surface | | | | | | | |
|---|---|---|---|---|---|---|---|
| number | A4 | A6 | A8 | A10 | A12 | A14 | A16 |
| S1 | 1.0241E+00 | −1.6226E−01 | 6.3759E−02 | −1.6410E−02 | 7.3153E−03 | −2.3925E−03 | 1.1519E−03 |
| S2 | 1.5283E−01 | −2.8176E−02 | 2.6355E−03 | −1.2613E−03 | −1.5054E−03 | 1.1260E−04 | 1.0106E−04 |
| S3 | 6.1233E−03 | −5.4528E−03 | −6.5342E−03 | −9.1381E−04 | 1.4625E−04 | 2.0590E−04 | 5.3207E−05 |
| S4 | 5.0789E−02 | −1.9462E−03 | −9.3810E−04 | −4.0530E−04 | 3.4262E−04 | −1.2307E−04 | 7.5756E−05 |
| S5 | 3.1919E−03 | 3.9877E−04 | −5.3406E−04 | 1.5949E−04 | −1.0788E−04 | 7.3197E−05 | −4.0573E−05 |
| S6 | 3.3090E−02 | 7.7986E−04 | −2.0687E−03 | 4.6059E−03 | −3.0459E−03 | 8.8260E−04 | −1.8994E−04 |
| S7 | −1.5663E−01 | 1.0581E−02 | −2.9067E−03 | 8.3072E−04 | 4.3325E−04 | 7.6492E−04 | −1.5544E−04 |
| S8 | −9.9689E−02 | −2.8103E−02 | 9.5094E−03 | −1.0052E−04 | 2.5635E−03 | 8.2519E−04 | 1.2727E−03 |
| S9 | −1.1989E−01 | −5.3727E−03 | −8.4099E−04 | 4.6551E−03 | 1.2781E−03 | 3.0327E−04 | 6.5360E−04 |
| S10 | 1.8272E−02 | −1.7212E−03 | −8.5561E−03 | 6.3750E−03 | 1.6490E−03 | 1.1186E−03 | −1.5045E−03 |
| S11 | −4.8043E−01 | −1.4103E−02 | 2.2717E−03 | −5.4032E−03 | −3.3950E−04 | −2.4758E−03 | 5.1414E−04 |
| S12 | 1.5017E−01 | −5.3166E−02 | 1.8958E−02 | −1.3314E−02 | 3.5838E−03 | −4.3129E−03 | 2.8585E−03 |
| S13 | −1.2033E+00 | 1.5079E−01 | −3.8009E−03 | −2.3672E−03 | 6.9533E−03 | −3.9861E−03 | 5.7022E−03 |
| S14 | −2.9346E+00 | 5.1013E−01 | −1.1206E−01 | 3.7928E−02 | −9.7592E−03 | 3.1089E−03 | 2.7299E−03 |
| Surface | | | | | | | |
| number | A18 | A20 | A22 | A24 | A26 | A28 | A30 |
| S1 | −6.5848E−04 | 3.4305E−04 | −1.2033E−04 | 1.7675E−05 | 1.2618E−05 | −2.0987E−05 | 0.0000E+00 |
| S2 | 3.8403E−04 | −2.0688E−04 | 1.1310E−04 | −6.2373E−05 | 0.0000E+00 | 0.0000E+00 | 0.0000E+00 |
| S3 | −3.4609E−05 | 1.5139E−05 | −1.3011E−05 | −8.5771E−07 | −5.3694E−06 | 6.0496E−06 | 0.0000E+00 |
| S4 | −9.0576E−05 | 5.2309E−05 | −2.3398E−05 | 4.0945E−05 | −1.6480E−05 | 0.0000E+00 | 0.0000E+00 |
| S5 | 5.5344E−05 | −1.8402E−05 | 2.6374E−05 | −1.0517E−05 | 0.0000E+00 | 0.0000E+00 | 0.0000E+00 |
| S6 | −1.3229E−04 | −6.1860E−05 | −7.8401E−06 | −1.4136E−04 | −2.7918E−04 | −8.5457E−05 | 0.0000E+00 |
| S7 | 7.7935E−05 | −1.2762E−04 | 7.2698E−05 | −8.6614E−05 | 2.9255E−05 | 0.0000E+00 | 0.0000E+00 |
| S8 | −4.1797E−04 | −2.0023E−04 | −4.1328E−05 | −9.1186E−05 | −4.6933E−06 | 2.4851E−05 | 0.0000E+00 |
| S9 | −6.3380E−04 | −2.7067E−04 | 1.3876E−04 | −1.5488E−04 | 7.6249E−05 | 0.0000E+00 | 0.0000E+00 |
| S10 | −1.2047E−03 | −3.7049E−04 | −4.9730E−04 | 2.2383E−04 | 1.1789E−04 | −3.4906E−05 | 0.0000E+00 |
| S11 | −1.2450E−05 | 4.8510E−05 | 1.0727E−04 | −1.4879E−04 | 9.5149E−05 | 0.0000E+00 | 0.0000E+00 |
| S12 | −6.8389E−04 | 1.9074E−05 | 7.3455E−05 | −2.3307E−04 | −1.1309E−04 | 1.3152E−04 | 0.0000E+00 |
| S13 | −3.5847E−03 | 1.2567E−04 | 5.5425E−04 | −4.1794E−04 | 1.2581E−04 | 0.0000E+00 | 0.0000E+00 |
| S14 | −3.4904E−03 | 1.4870E−03 | −3.5932E−04 | 8.8238E−05 | 1.1333E−04 | −1.0342E−04 | 0.0000E+00 |

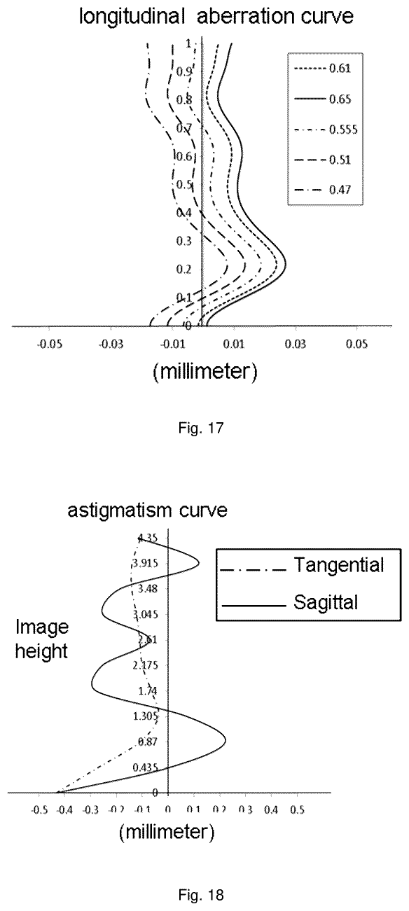

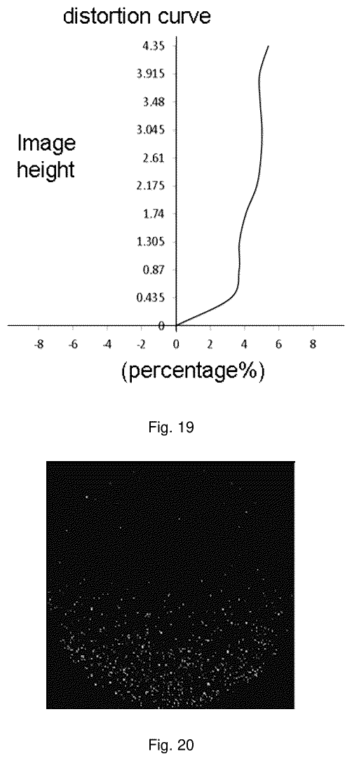

FIG. 17 shows a longitudinal aberration curve of the optical imaging lens assembly in Example 3. The longitudinal aberration curve represents that a convergence focus of light having different wavelengths will be deviated after the light passes through the optical imaging lens assembly. FIG. 18 shows an astigmatism curve of the optical imaging lens assembly in Example 3. The astigmatism curve represents curvature of a tangential image surface and a sagittal image surface. FIG. 19 shows a distortion curve of the optical imaging lens assembly in Example 3. The distortion curve represents distortion magnitude values corresponding to different angles of view.

According to FIGS. 17 to 19, it may be known that the optical imaging lens assembly provided in Example 3 can achieve desirable imaging quality.

To sum up, Examples 1 to 3 satisfy relations shown in Table 10.

TABLE 10

| | Example | | | | | | | | |
|---|---|---|---|---|---|---|---|---|---|
| Conditional Expression | 1-1 | 1-2 | 1-3 | 2-1 | 2-2 | 2-3 | 3-1 | 3-2 | 3-3 |
| EP45/CT5 | 2.67 | 2.40 | 2.77 | 3.04 | 2.44 | 3.00 | 2.40 | 1.90 | 1.90 |
| R8/R9 | 2.00 | 2.00 | 2.00 | 3.78 | 3.78 | 3.78 | 1.89 | 1.89 | 1.89 |
| d4s/(f4 − f5) | 0.26 | 0.26 | 0.25 | 0.28 | 0.28 | 0.30 | 0.35 | 0.36 | 0.36 |
| f2/(d1s − d2s) | 6.84 | 6.84 | 5.84 | 7.78 | 5.96 | 7.31 | 4.57 | 4.57 | 4.72 |
| (D1m − d1m)/T12 | 5.54 | 5.33 | 3.15 | 5.08 | 4.77 | 3.81 | 4.09 | 4.28 | 2.93 |
| d2s/R4 − d2m/R5 | 0.62 | 0.62 | 0.62 | 0.21 | 0.21 | 0.21 | −0.08 | −0.08 | −0.08 |
| (D3m − d3s)/(f4 − f3) | 11.30 | 4.25 | 7.49 | 3.58 | 2.15 | 2.67 | −4.11 | −4.13 | −2.93 |
| d2m/(DT22 − DT31) | 6.22 | 6.22 | 6.22 | −17.86 | −17.86 | −17.86 | 2.11 | 2.11 | 2.11 |
| \|D2s − D1s\|/(DT12 − DT22) | 0.05 | 0.05 | 0.06 | 0.05 | 0.05 | 0.02 | 0.09 | 0.09 | 0.05 |
| d5s/R10 − d4m/R9 | 0.67 | 0.24 | 0.67 | 0.91 | 0.65 | 1.01 | 0.97 | 0.80 | 0.73 |
| (d1s − d2s)/(d3s − d2s) | 2.61 | 0.34 | 2.90 | 1.66 | 0.56 | 1.83 | 2.81 | 2.18 | 2.98 |
| d5s/DT52 − d5m/DT61 | 0.22 | 0.35 | 0.21 | 0.19 | 0.22 | 0.18 | 0.18 | 0.18 | 0.27 |
| d6s/(CT6 + CT7) | 2.61 | 2.61 | 2.61 | 2.48 | 2.48 | 2.53 | 3.30 | 3.63 | 3.96 |
| D1s/D6m + DT11/DT72 | 1.94 | 1.94 | 1.73 | 2.04 | 2.04 | 1.87 | 2.01 | 2.03 | 1.85 |

Apparently, the examples described above are merely some examples rather than all examples of the disclosure. On the basis of the examples of the disclosure, all other examples obtained by those of ordinary skill in the art without making inventive efforts should all fall within the scope of protection of the disclosure.

It should be noted that terms used herein are merely for describing particular embodiments and are not intended to limit illustrative embodiments of the disclosure. As used herein, singular is also intended to include plural unless the context clearly points out singular or plural. In addition, it should be understood that terms “comprise” and/or “include” used in the description indicate the presence of features, steps, operations, devices, assemblies and/or their combinations.

It should be noted that the terms “first”, “second”, etc., in the description and claims of the disclosure and in the above accompanying drawings, are used to distinguish between similar objects and not certainly to describe particular sequence or order. It should be understood that data used in this way may be interchanged under appropriate circumstances such that the embodiments of the disclosure described herein may be implemented in sequence other than those illustrated or described herein.

The above examples are merely preferred examples of the disclosure and are not intended to limit the disclosure. For those skilled in the art, the disclosure may be variously modified and changed. Any modifications, equivalent substitutions, improvements, etc. made within the spirit and principles of the disclosure shall fall within the scope of protection of the disclosure.

1. An optical imaging lens assembly, comprising a lens barrel, seven lenses and a plurality of spacers, wherein the seven lenses and the plurality of spacers are arranged in the lens barrel,
the seven lenses comprise, in sequence from an object side to an image side, a first lens having negative refractive power, a second lens having positive refractive power, a third lens having positive refractive power, a fourth lens having positive refractive power, a fifth lens having negative refractive power, a sixth lens having positive refractive power and a seventh lens having negative refractive power, and an air gap is provided between every two adjacent lenses of the first lens to the seventh lens;
the plurality of spacers at least comprise a fourth spacer and a fifth spacer, the fourth spacer is located between the fourth lens and the fifth lens and abuts against part of an image-side surface of the fourth lens, and the fifth spacer is located between the fifth lens and the sixth lens and abuts against part of an image-side surface of the fifth lens;
a distance EP45 between an image-side surface of the fourth spacer and an object-side surface of the fifth spacer on an optical axis and a center thickness CT5 of the fifth lens satisfy: 1<EP45/CT5<4;
a curvature radius R8 of the image-side surface of the fourth lens and a curvature radius R9 of an object-side surface of the fifth lens satisfy: 1<R8/R9<4; and
an inner diameter d4s of the object-side surface of the fourth spacer, an effective focal length f4 of the fourth lens and an effective focal length f5 of the fifth lens satisfy: 0<d4s/(f4−f5)<0.5.

2. The optical imaging lens assembly as claimed in claim 1, wherein the plurality of spacers further comprise a first spacer and a second spacer, the first spacer is located between the first lens and the second lens and abuts against part of an image-side surface of the first lens, the second spacer is located between the second lens and the third lens and abuts against part of an image-side surface of the second lens, and
an inner diameter d1s of an object-side surface of the first spacer, an inner diameter d2s of an object-side surface of the second spacer and an effective focal length f2 of the second lens satisfy: 2<f2/(d1s−d2s)<10.

3. The optical imaging lens assembly as claimed in claim 1, wherein the plurality of spacers further comprise a first spacer, the first spacer is located between the first lens and the second lens and abuts against part of an image-side surface of the first lens, and
an inner diameter dim of an image-side surface of the first spacer, an outer diameter D1m of the image-side surface of the first spacer, and a distance T12 between the image-side surface of the first lens and an object-side surface of the second lens on the optical axis satisfy: 2<(D1m−d1m)/T12<6.

4. The optical imaging lens assembly as claimed in claim 1, wherein the plurality of spacers further comprise a second spacer, the second spacer is located between the second lens and the third lens and abuts against part of an image-side surface of the second lens, and
an inner diameter d2s of an object-side surface of the second spacer, an inner diameter d2m of an image-side surface of the second spacer, a curvature radius R4 of the image-side surface of the second lens and a curvature radius R5 of an object-side surface of the third lens satisfy: −0.5<d2s/R4−d2m/R5<1.

5. The optical imaging lens assembly as claimed in claim 1, wherein the plurality of spacers further comprise a third spacer, the third spacer is located between the third lens and the fourth lens and abuts against part of an image-side surface of the third lens, and
an inner diameter d3s of an object-side surface of the third spacer, an outer diameter D3m of an image-side surface of the third spacer, an effective focal length f3 of the third lens and an effective focal length f4 of the fourth lens satisfy: −5<(D3m−d3s)/(f4−f3)<15.

6. The optical imaging lens assembly as claimed in claim 1, wherein the plurality of spacers further comprise a second spacer, the second spacer is located between the second lens and the third lens and abuts against part of an image-side surface of the second lens, and
an inner diameter d2m of an image-side surface of the second spacer, an effective diameter DT31 of a central light-transmitting region of an object-side surface of the third lens and an effective diameter DT22 of a central light-transmitting region of the image-side surface of the second lens satisfy: −18<d2m/(DT22−DT31)<8.

7. The optical imaging lens assembly as claimed in claim 1, wherein the plurality of spacers further comprise a first spacer and a second spacer, the first spacer is located between the first lens and the second lens and abuts against part of an image-side surface of the first lens, the second spacer is located between the second lens and the third lens and abuts against part of an image-side surface of the second lens, and
an outer diameter Dis of an object-side surface of the first spacer, an outer diameter D2s of an object-side surface of the second spacer, an effective diameter DT12 of a central light-transmitting region of the image-side surface of the first lens and an effective diameter DT22 of a central light-transmitting region of the image-side surface of the second lens satisfy: 0<|D2s−D1s|/(DT12−DT22)<0.1.

8. The optical imaging lens assembly as claimed in claim 1, wherein an inner diameter d5s of the object-side surface of the fifth spacer, an inner diameter d4m of the image-side surface of the fourth spacer, a curvature radius R9 of the object-side surface of the fifth lens and a curvature radius R10 of the image-side surface of the fifth lens satisfy: 0<d5s/R10−d4m/R9<1.5.

9. The optical imaging lens assembly as claimed in claim 1, wherein the plurality of spacers further comprise a first spacer, a second spacer and a third spacer, the first spacer is located between the first lens and the second lens and abuts against part of an image-side surface of the first lens, the second spacer is located between the second lens and the third lens and abuts against part of an image-side surface of the second lens, the third spacer is located between the third lens and the fourth lens and abuts against part of an image-side surface of the third lens, and
the second spacer of the plurality of spacers has a minimum inner diameter; and
an inner diameter d1s of an object-side surface of the first spacer, an inner diameter d2s of an object-side surface of the second spacer and an inner diameter d3s of an object-side surface of the third spacer satisfy: 0<(d1s−d2s)/(d3s−d2s)<3.

10. The optical imaging lens assembly as claimed in claim 1, wherein an inner diameter d5s of the object-side surface of the fifth spacer, an inner diameter d5m of an image-side surface of the fifth spacer, an effective diameter DT52 of a central light-transmitting region of the image-side surface of the fifth lens and an effective diameter DT61 of a central light-transmitting region of an object-side surface of the sixth lens satisfy: 0<d5s/DT52−d5m/DT61<0.5.

11. The optical imaging lens assembly as claimed in claim 1, wherein the plurality of spacers further comprise a sixth spacer, the sixth spacer is located between the sixth lens and the seventh lens and abuts against part of an image-side surface of the sixth lens, and
an inner diameter d6s of an object-side surface of the sixth spacer, a center thickness CT6 of the sixth lens and a center thickness CT7 of the seventh lens satisfy: 2<d6s/(CT6+CT7)<5.

12. The optical imaging lens assembly as claimed in claim 1, wherein the plurality of spacers further comprise a first spacer and a sixth spacer, the first spacer is located between the first lens and the second lens and abuts against part of an image-side surface of the first lens, the sixth spacer is located between the sixth lens and the seventh lens and abuts against part of an image-side surface of the sixth lens, and
an outer diameter D1s of an object-side surface of the first spacer, an outer diameter D6m of an image-side surface of the sixth spacer, an effective diameter DT11 of a central light-transmitting region of an object-side surface of the first lens and an effective diameter DT72 of a central light-transmitting region of an image-side surface of the seventh lens satisfy: 1.7<D1s/D6m+DT11/DT72<2.1.
